(19) United States
(12) Patent Application Publication
(10) Pub. No.: US 2007/0228929 A1
(43) Pub. Date: Oct. 4, 2007

(54) Display apparatus

(75) Inventors: Mutsumi Suzuki, Kodaira (JP); Masakazu Sagawa, Inagi (JP); Toshiaki Kusunoki, Tokorozawa (JP)

Correspondence Address: MILES & STOCKBRIDGE PC, 1751 PINNACLE DRIVE, SUITE 500, MCLEAN, VA, 22102-3833, US

(73) Assignee: Hitachi Displays, Ltd.

(21) Appl. No.: 11/657,046

(22) Filed: Jan. 24, 2007

(30) Foreign Application Priority Data
Mar. 28, 2006 (JP) 2006-086859

(51) Int. Cl. H01J 1/00; H01J 1/62; H01J 19/06; H01J 63/04

(52) U.S. Cl. 313/495; 313/311; 313/497

(57) ABSTRACT

In a matrix electron emitter display using a thin-film electron emitter, a required resistance value of a top electrode, which value is determined by voltage drop at the top electrode, is small, and selection of a material and film thickness of the top electrode have been limited. Use of cathode structure which improves the capability of feeding from a feeding line to a thin-film electron emitter element improves the electron emission efficiency, and permits achieving higher luminance and lower power of a display apparatus.

### CLAIM OF PRIORITY

The present application claims priority from Japanese application JP 2006-086859 filed on Mar. 28, 2006, the content of which is hereby incorporated by reference into this application.

### FIELD OF THE INVENTION

The present invention relates to a display apparatus which displays an image by using electron-emitter elements and phosphors placed in a matrix-form.

### BACKGROUND OF THE INVENTION

A matrix electron emitter display, where an intersection of mutually orthogonal electrode groups is provided as a pixel, has an electron-emitter element provided in each pixel, adjusts a voltage applied to each electron-emitter element or a pulse width to thereby adjust the amount of emitted electrons, accelerates the emitted electrons in vacuum, then bombards the electrons onto a phosphor, and causes the bombarded portion of the phosphor to emit light. Those which are adopted as electron-emitter elements use a field-emission type cathode, an MIM (Metal-Insulator-Metal) type electron emitter, a carbon-nanotube cathode, a diamond cathode, a surface-conduction electron-emitter element, a ballistic type electron emitter, or the like. As described above, the matrix electron emitter display refers to a cathodoluminescent flat-panel display which combines electron-emitter elements and a phosphor.

As shown in FIG. 2, a matrix electron emitter display is constructed such that a cathode plate 601 where electron-emitter elements are placed and a phosphor plate 602 where phosphors are formed are so placed as to oppose each other. In order that electrons emitted from the electron-emitter element 301 reach the phosphor plate to thereby excite the phosphor to emit light, a space enclosed by the cathode plate, the phosphor plate, and a frame component 603 is kept vacuum. To withstand the atmospheric pressure from the outside, spacers 60 are inserted between the cathode plate and the phosphor plate.

The phosphor plate 602 has an acceleration electrode 122, to which a voltage of approximately as high as 3 KV to 10 KV is applied. Electrons emitted from the electron-emitter element 301 are first accelerated by this high voltage and then bombarded onto the phosphor, which is thereby excited to emit light.

There is a thin-film electron emitter as an electron-emitter element for use in a matrix electron emitter display. The thin-film electron emitters have structure in which a top electrode, an electron acceleration layer, and a base electrode are laid. The thin-film electron emitters include an MIM (Metal-Insulator-Metal) type electron emitter, a MOS (Metal-oxide Semiconductor) type electron emitter, a ballistic type electron emitter, and the like. The MOS type electron emitter uses a stacked film composed of semiconductor and insulator for the electron acceleration layer, which is described in, for example, Japanese Journal of Applied Physics, Vol. 36, Part 2, No. 7B, pp. L939 to L941 (1997). The ballistic type electron emitter uses porous silicon or the like for the electron acceleration layer, which is described in, for example, Japanese Journal of Applied Physics, Vol. 34, Part 2, No. 6A, pp. L705 to L707 (1995). The thin-film electron emitter emits into vacuum electrons accelerated in the electron acceleration layer.

FIG. 3 is an energy-band diagram of operation principles of a thin-film electron emitter, showing a base electrode 13, an electron acceleration layer 12, and a top electrode 11 laid therein and a state in which a positive voltage is applied to the top electrode 11. For the MIM type electron emitter, an insulator is used as the electron acceleration layer 12. The voltage applied between the top electrode and the bottom electrode generates an electric field inside the electron acceleration layer 12. This electric field causes electrons to flow from the inside of the base electrode 13 into the electron acceleration layer 12 due to a tunneling phenomenon. These electrons are accelerated by the electric field in the electron acceleration layer 12, turning into hot electrons. Part of these hot electrons, upon passing through the inside of the top electrode 11, lose their energy due to inelastic scattering or the like. At a time when the electrons reach the interface between the top electrode 11 and the vacuum (that is, surface of the top electrode), those electrons having a larger kinetic energy than a work function Φ of the surface are emitted into vacuum 10. In the present specification, due to the presence of these hot electrons, a current flowing between the base electrode 13 and the top electrode 11 is called a diode current Jd and a current emitted into the vacuum is called a emission current Je.

Compared to the field-emission type cathode, the thin-film electron emitter has characteristics that: it has stronger resistance against surface contamination and small divergence of emitted electron beams, thus permitting achieving a high-resolution display apparatus; it has a small operation voltage; a circuit driver is with low voltage; and the like, which are suitable for a display apparatus.

On the other hand, in the thin-film electron emitter, only part of drive current is emitted into the vacuum (emission current Je). Here, the drive current refers to a current flowing between the top electrode and the base electrode and is called a diode current Jd. Ratio α between the emission current Je and the diode current Jd (electron emission ratio α=Je/Jd) is approximately 0.01 to 1%. That is, to obtain an amount Je of the emission current, a drive current (diode current) of Jd=Je/a needs to be supplied from the drive circuit to the thin-film electron emitter.

As described above, in the matrix electron emitter display using the thin-film electron emitter as an electron-emitter element, a current for driving the element is large, thus requiring electrode wiring to be provided with low resistance. In a display apparatus which performs display in a line-at-a-time drive method in particular, a current corresponding to the number of pixels in one row flows in a scan line, and thus the resistance of an electrode corresponding to the scan line (scan electrode) needs to be small. Methods of providing small wiring resistance include: using a material having low resistance, such as Al or the like, for electrode wiring; providing a large film thickness of the scan electrode; providing a wide wiring width; and the like.

Providing a large film thickness of the electrode to provide the electrode wiring with low resistance results in complicated wiring manufacturing and fabrication processes. To cope with this problem, the inventor has disclosed a structure of a thin-film electron emitter achieved by a wiring pattern in a “stripe-form” which permits easy fabrication of wiring with a large film thickness (JP-A No. 2004-363075).

In a patterning process, the use of a pattern which is required to have pattern-alignment accuracy only in one direction, either a longitudinal direction or a lateral direction, rather than a pattern which is required to have pattern-alignment accuracy in the two directions including the longitudinal and the lateral directions permits easy fabrication. In the present specification, a shape required to have pattern-alignment accuracy only in one direction is called “stripe-form” or “stripe-shape” which means that the accuracy only in one-dimensional direction is required. An electrode of a stripe-form pattern is called “stripe electrode” or “stripe-form electrode”. Especially when a printing method such as screen-printing or the like is used as a patterning method, the stripe-form pattern is preferable since it allows stretching of the print-screen. The stretching of the print-screen is a phenomenon that the screen stretches in a direction parallel to a movement direction of a squeegee with an increasing number of times of printing.

For the electron emitter substrate, an image display area where electron emitters are placed in a matrix-form and a periphery area where a terminal locating area and the like are placed are discussed separately. The image display area generally requires higher fabrication accuracy and pattern-alignment accuracy than the periphery area. Therefore, it is important that the pattern shape inside the image display area be a stripe-form. The periphery area requires low fabrication accuracy and also generally requires a small number of patterns to be aligned, and thus does not necessarily have to be shaped into a stripe-form.

Therefore, in the present specification, those which have an image display area with wiring of a stripe-form are called “stripe-shape” or “stripe electrode”. That is, those whose patterns are not straight in the periphery area but are formed in a stripe-shape in an image display area fall within the range of “stripe electrodes”.

To reduce the drive current in a matrix electron emitter display which uses a thin-film electron emitter as an electron-emitter element, the electron emission ratio α=Je/Jd needs to be increased. One of methods of increasing the electron emission ratio α is providing a small film thickness of the top electrode. This reduces the scattering probability of hot electrons in the top electrode, thus resulting in an increase in the electron emission ratio α.

### SUMMARY OF THE INVENTION

In a matrix electron emitter display using a thin-film electron emitter as an electron-emitter element, attempt to provide a small film thickness of a top electrode results in deficiency in the capability of feeding from a feeding electrode to the top electrode, thus posing a problem of failure to provide a film thickness of a certain degree or more. This makes it difficult to increase the electron emission ratio α of the thin-film electron emitter.

The present invention provides a display apparatus with improved capability of feeding from the feeding electrode to the top electrode.

Outline of representative features of the present invention to be disclosed in the present application will be briefly described below.

One aspect of the present invention refers to an display apparatus includes: a cathode plate having: a plurality of thin-film electron emitters which have a base electrode, a top electrode, and an electron acceleration layer sandwiched between the base electrode and the top electrode and which emits electrons from a top electrode side by applying a voltage between the base electrode and the top electrode; a plurality of first electrode groups parallel to one another; and a plurality of second electrode groups parallel to one another, the first electrode groups being configured to feed power to the top electrode; a display panel having a phosphor screen substrate having a phosphor screen where a phosphor is formed which is excited by the electrons to emit light; and a drive circuit which drives the thin-film electron emitters, wherein each electrode (first electrode) forming the first electrode group is in a stripe-form, wherein a contact electrode electrically connected to the first electrode is provided which is electrically connected to the top electrode and provided along two or more adjacent sides of the electron-emission area of the thin-film electron emitter.

Another aspect of the present invention refers to an display apparatus including: a cathode plate having: a plurality of thin-film electron emitters which have a base electrode, a top electrode, and an electron acceleration layer sandwiched between the base electrode and the top electrode and which emits electrons from a top electrode side by applying a voltage between the base electrode and the top electrode; a plurality of first electrode groups parallel to one another; and a plurality of second electrode groups parallel to one another, the first electrode groups being configured to feed power to the top electrode; a display panel having a phosphor screen substrate having a phosphor screen where a phosphor is formed which is excited by the electrons to emit light; and a drive circuit which drives the thin-film electron emitters, wherein the first electrode group is electrically connected to a contact electrode, which is electrically connected to the top electrode, wherein a first inter-layer insulator and a second inter-layer insulator are formed at an intersecting region between the first electrode group and the second electrode group, wherein the second inter-layer insulator is formed at perimeter of the electron-emission area on the first inter-layer insulator, and wherein the contact electrode is so formed as to cover a top and an edge facing the electron-emission area of the second inter-layer insulator.

Still another aspect of the present invention refers to an display apparatus including: a cathode plate having: a plurality of thin-film electron emitters which have a base electrode, a top electrode, and an electron acceleration layer sandwiched between the base electrode and the top electrode and which emits electrons from a top electrode side by applying a voltage between the base electrode and the top electrode; a plurality of first electrode groups parallel to one another; and a plurality of second electrode groups parallel to one another, the first electrode groups being configured to feed power to the top electrode; a display panel having a phosphor screen substrate having a phosphor screen where a phosphor is formed which is excited by the electrons to emit light; and a drive circuit which drives the thin-film electron emitters, wherein the first electrode group is electrically connected to a contact electrode, which is electrically connected to the top electrode, wherein a first inter-layer insulator and a second inter-layer insulator are formed at an intersecting region between the first electrode group and the second electrode group, wherein a patterning process of the second inter-layer insulating film is performed prior to a deposition process of the contact electrode.

Still another aspect of the present invention refers to an display apparatus that includes: a cathode plate having: a plurality of thin-film electron emitters which have a base electrode, a top electrode, and an electron acceleration layer sandwiched between the base electrode and the top electrode and which emits electrons from a top electrode side by applying a voltage between the base electrode and the top electrode; a plurality of first electrode groups parallel to one another; and a plurality of second electrode groups parallel to one another, the first electrode groups being configured to feed power to the top electrode; a display panel having a phosphor screen substrate having a phosphor screen where a phosphor is formed which is excited by the electrons to emit light; and a drive circuit which drives the thin-film electron emitters, wherein each electrode (first electrode) forming the first electrode group is in a stripe-form, wherein a contact electrode electrically connected to the first electrode is provided which is electrically connected to the top electrode to thereby form a feeding side and provided along two or more adjacent feeding sides of the electron-emission area of the thin-film electron emitter, wherein the second inter-layer insulator is formed at perimeter of the electron-emission area on the first inter-layer insulator, and wherein the contact electrode is so formed as to cover a top and an edge facing the electron-emission area of the second inter-layer insulator.

The capability of feeding from the feed wiring to the top electrode can be represented by the amount of voltage drop between the feeding electrode and the top electrode. That is, a smaller amount of voltage drop results in higher feeding capability. Thus, the amount of voltage drop is to be estimated.

FIGS. 4A to 4C show the structure of a thin-film electron emitter of a conventional type. Of the thin-film electron emitters placed in a matrix-form, a portion corresponding to one sub-pixel is shown (element corresponding to a phosphor of one color of one pixel). At a place where a feeding line and a data line intersect with each other (corresponding to one sub-pixel of the display apparatus), an electron-emission area is formed. FIG. 4A is a plan view, FIG. 4B is a cross section, and FIG. 4C is a diagram schematically showing the amount of voltage drop while the thin-film electron emitter is in operation.

Although not shown in FIGS. 4A to 4C, from the contact electrode to the farthest end of the electron-emission area, the top electrode is continuously formed on the topmost layer and is electrically connected to the contact electrode. The top electrode typically has a film thickness of approximately 1 nm to 20 nm. The contact electrode typically has a film thickness of 10 nm to 500 nm, and has sufficiently smaller sheet resistance than the top electrode. Therefore, for estimation of the feeding capability, the amount of voltage drop between the contact electrode and the top electrode on the farthest end of the electron-emission area should be calculated.

FIG. 4 C is a diagram schematically showing the amount of voltage drop during operation. It is assumed that voltage drop on the second inter-layer insulator (length d2) is ΔV2, voltage drop at the edge (step) of the second inter-layer insulator is ΔVst, voltage drop on the first inter-layer insulating film (length d1) is ΔV1, and voltage drop at the electron-emission area (length L) is ΔVem. In the electron-emission area, since a current flows between the top electrode and the base electrode, a current flowing in the top electrode differs depending on places, as shown in FIG. 4C, and a curved line of voltage drop becomes closer to parabolic. To simplify formulation, the diode current density inside the electron-emission area is approximated with a fixed value (=J) inside the electron-emission area. Assuming that a position x inside the electron-emission area is a distance from the feed side, voltage drop ΔVem(x) at the place x can be expressed by formula below:

$$Δ {V}_{em} ( x ) = ρ {JL}^{2} ( β - \frac{{β}^{2}}{2} ) , β = \frac{x}{L} \qquad [ Formula 1 ]$$

Here, L denotes a length of the electron-emission area (FIGS. 4A to 4C). Therefore, voltage drop at the farthest end of the electron-emission area (x=L) ΔVem=ΔVem(x=L) can be expressed by formula below.

$$Δ {V}_{em} = Δ {V}_{em} ( x = L ) = \frac{1}{2} ρ {JL}^{2} \qquad [ Formula 2 ]$$

Hereinafter, it is assumed that ΔVi=ΔV1+ΔV2 and d=d1+d2.

FIG. 5 shows estimated amounts of voltage drop with different shapes of the contact electrode. Here, ρ represents the sheet resistance of the top electrode, J represents the density of diode current flowing through the thin-film electron emitter, a and b represent lengths of sides of the electron-emission area, and r represents resistance per unit length at the step of the second inter-layer insulating film.

Here, “feeding side” is defined for the electron-emission area. The feeding side is defined as a side, of sides forming the electron-emission area, which works as a feed path(s) from the busline electrode to the top electrode on the electron-emission area. As previously described, in the calculation of voltage drop at the feed path, since a voltage drop along the contact electrode is ignorable in many cases compared to voltage drop at the top electrode, the feeding side is assumed equivalent to a side assumed to work as a feed path(s) from the contact electrode to the top electrode on the electron-emission area. Therefore, in the standpoint of the structure, “feeding side” is defined as a side, of the sides forming the electron-emission area, along which the contact electrode extends.

For calculation of ΔVem, the formula 2 described above is used. As can be seen from the formula 2 and FIG. 5, ΔVem is proportional to a square of a distance from the feed point. Therefore, feeding from a side of the longer side(s) (side having a side length b in FIG. 5) results in small ΔVem, which corresponds to C and D in FIG. 5. That is, the use of the longer side, of sides of the electron-emission area, as the feeding side results in high feeding capability.

For this reason, even feeding from all the four sides of the electron-emission area has only small difference in the feeding capability from feeding from the three sides in (D) of FIG. 5. With structure in which all the sides of the electron-emission area are surrounded by the contact electrode, the alignment margins of photo masks are more restricted than the three-side feed structure. Thus, the structure in which the side of the electron-emission area opposite to the busline electrode is not provided as the feeding side can be proved to be a structure which is easy to build and also which provides high feeding capability.

The bottom three rows of FIG. 5 show relative values of amounts of voltage drop with the respective structures where the amount of voltage drop for the stripe structure according to conventional technology is equal to 1. Here, it is assumed that b=3a. In a color display apparatus, since one pixel is formed of a set of three sub-pixels (corresponding to red, green, and blue, respectively) in many cases, b/a=3 denotes a typical ratio of a longer side to shorter side in length.

FIG. 6 shows amounts of voltage drop estimated by using typical parameters by use of the calculation formula of FIG. 5, where ρ=300Ω/□. As can be seen from FIG. 6, the overall amount of voltage drop ΔV=ΔVst+ΔVi+ΔVem is 0.14V for a conventional single-side feed type but decreases to 0.03V for the three-side feed type. That is, a larger number of sides of the contact electrode facing the side of the electron-emission area results in higher feeding capability. In another word, a larger number of feeding sides results in higher feeding capability. This is a first method of improving the feeding capability. FIG. 1 shows a detailed example of cathode structure of the three-side feed type shown in (D) of FIG. 5. A method of fabricating this structure and the like will be described in detail referring to examples below.

Moreover, use of the cathode structure in which the step of the second inter-layer insulator is eliminated provides the overall amount of voltage drop ΔV=ΔVi+ΔVem. Thus, as can be seen from FIG. 6, ΔV decreases to 0.04V even with the same single-side feed type. This is a second method of improving the feeding capability.

As described above, the first and second methods of improving the feeding capability can be effective even when used separately from each other. However, use of the two methods in combination provides ΔV=ΔVi+ΔVem=5 mV for the three-side feed of FIG. 6, resulting in an even smaller amount of voltage drop, that is, an improvement in the feeding capability.

As described above, according to the present invention, with structure such that feeding to many sides of the top electrode in the electron-emission area is performed, the capability of feeding from the feeding electrode to the top electrode improves, which makes it possible to reduce the top electrode's thickness, thus resulting in an improvement in the electrons electron emission ratio.

Moreover, according to the present invention, with structure such that a step of the second inter-layer insulator is removed from the feed path from the feeding electrode to the top electrode, the capability of feeding from the feeding electrode to the top electrode improves, which makes it possible to reduce the top electrode's thickness, thus resulting in an improvement in the electrons electron emission ratio. In this manner, the display apparatus based on the present invention can achieve a display apparatus with lower power consumption than a conventional one.

### BRIEF DESCRIPTION OF THE DRAWINGS

FIG. 1 is a diagram showing one example of cathode structure of a display panel of a display apparatus according to the present invention;

FIG. 2 is a schematic diagram showing in cross section a matrix electron emitter display;

FIG. 3 is a diagram for describing an electron emission mechanism of a thin-film electron emitter;

FIG. 4 is a diagram schematically showing the amount of voltage drop in the thin-film electron emitter corresponding to one pixel in the display panel;

FIG. 5 shows change in the amount of voltage drop caused by change in the structure of a contact electrode;

FIG. 6 is a diagram showing calculated values of the amount of voltage drop;

FIG. 7 is a plan view showing the structure of the display panel of the display apparatus according to the present invention;

FIG. 8 is a cross section showing the structure of the display panel of the display apparatus according to the present invention;

FIG. 9 is a plan view showing part of the cathode plate of example 1 of the display apparatus according to the present invention;

FIGS. 10A and 10B are cross sections showing part of the cathode plate of the example 1 of the display apparatus according to the present invention;

FIGS. 11A, 11B, and 11C are diagrams for describing fabrication processes of the cathode plate of the example 1 of the display apparatus according to the present invention;

FIGS. 12A, 12B, and 12C are diagrams for describing fabrication processes of the cathode plate of the example 1 of the display apparatus according to the present invention;

FIGS. 13A, 13B, and 13C are diagrams for describing fabrication processes of the cathode plate of the example 1 of the display apparatus according to the present invention;

FIGS. 14A, 14B, and 14C are diagrams for describing fabrication processes of the cathode plate of the example 1 of the display apparatus according to the present invention;

FIGS. 15A, 15B, and 15C are diagrams for describing fabrication processes of the cathode plate of the example 1 of the display apparatus according to the present invention;

FIGS. 16A, 16B, and 16C are diagrams for describing fabrication processes of the cathode plate of the example 1 of the display apparatus according to the present invention;

FIGS. 17A, 17B, and 17C are diagrams for describing fabrication processes of the cathode plate of the example 1 of the display apparatus according to the present invention;

FIGS. 18A, 18B, and 18C are diagrams for describing fabrication processes of the cathode plate of the example 1 of the display apparatus according to the present invention;

FIGS. 19A, 19B, and 19C are diagrams for describing fabrication processes of the cathode plate of the example 1 of the display apparatus according to the present invention;

FIG. 20 is a diagram showing wire connection between the display panel and drive circuits of the example 1 of the display apparatus according to the present invention;

FIG. 21 is a diagram showing a driving method of the example 1 of the display apparatus according to the present invention;

FIG. 22 is a plan view showing part of a cathode plate of example 2 of the display apparatus according to the present invention;

FIGS. 23A and 23B are cross sections showing part of the cathode plate of the example 2 of the display apparatus according to the present invention;

FIGS. 24A, 24B, and 24C are diagrams for describing fabrication processes of the cathode plate of the example 2 of the display apparatus according to the present invention;

FIGS. 25A, 25B, and 25C are diagrams for describing the fabrication processes of the cathode plate of the example 2 of the display apparatus according to the present invention;

FIGS. 26A, 26B, and 26C are diagrams for describing the fabrication processes of the cathode plate of the example 2 of the display apparatus according to the present invention;

FIGS. 27A, 27B, and 27C are diagrams for describing the fabrication processes of the cathode plate of the example 2 of the display apparatus according to the present invention;

FIG. 28 is a diagram for describing the fabrication processes of the cathode plate of the example 2 of the display apparatus according to the present invention;

FIGS. 29A, 29B, and 29C are diagrams showing part of a cathode plate of example 3 of the display apparatus according to the present invention;

FIGS. 30A, 30B, and 30C are diagrams showing part of the cathode plate of the example 4 of the display apparatus according to the present invention;

FIG. 31 is a diagram for explaining mask alignment tolerance of the example 4 of the display apparatus according to the present invention; and

FIG. 32 is a diagram showing the electron emission ratio in the display apparatus according to the present invention.

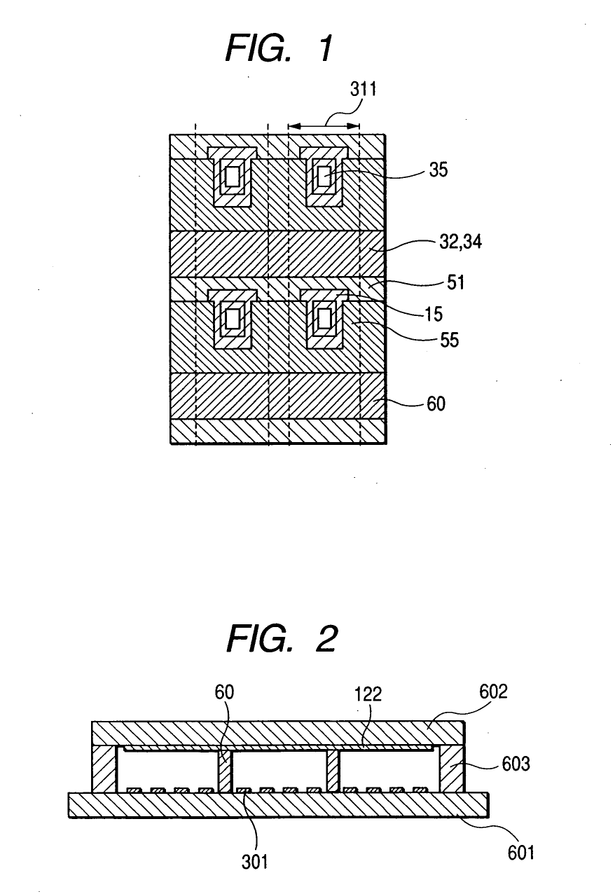

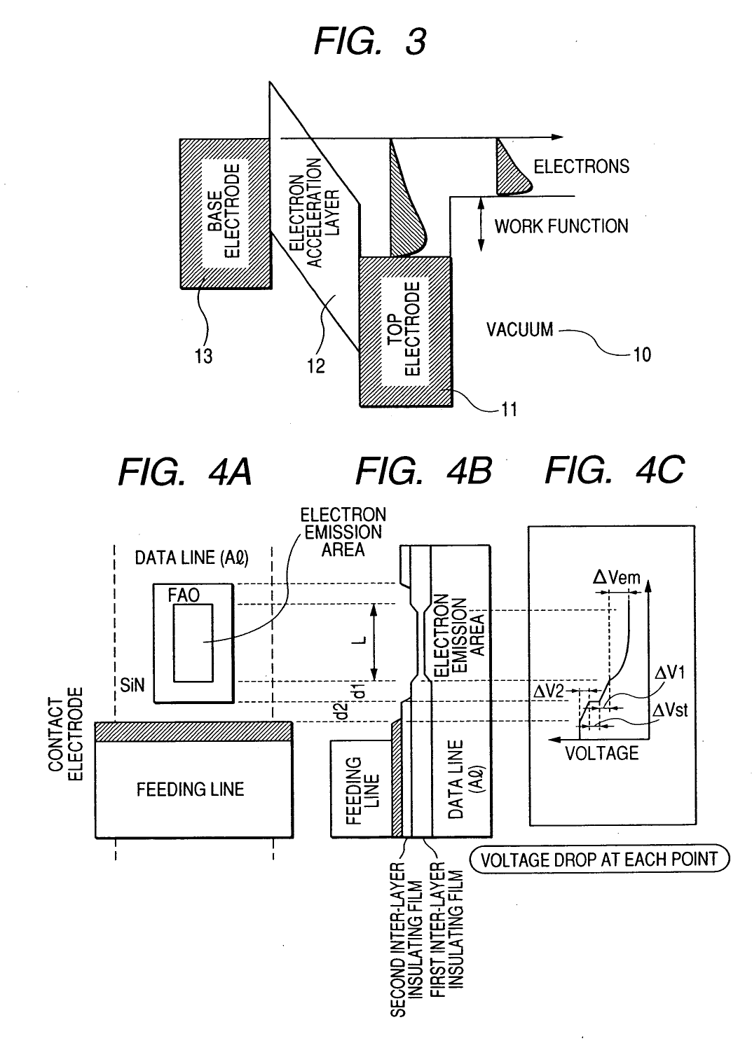

### DETAILED DESCRIPTION OF THE PREFERRED EMBODIMENTS

Hereinafter, a display apparatus according to the present invention will be described in more detail with reference to embodiments shown in several examples of the accompanying drawings.

### Embodiment 1

Embodiment 1 employing the present invention will be described. In this example, a thin-film electron emitter is used as an electron-emitter element 301. More specifically, an MIM (Metal-Insulator-Metal) type electron emitter is used.

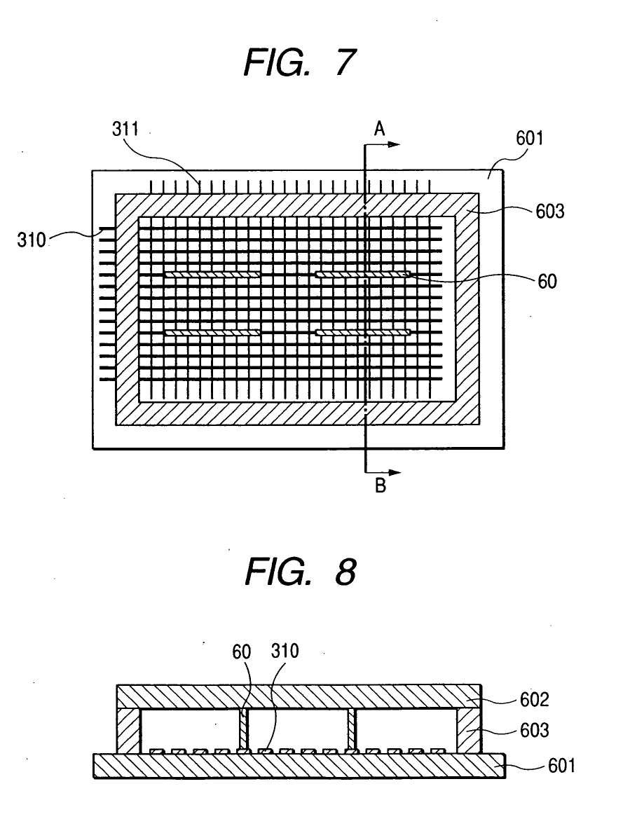

FIG. 7 is a plan view of a display panel used in this example. FIG. 8 is a cross section along A-B of FIG. 7. In FIG. 8, of components forming a cathode plate 601, only scan electrodes 310 are illustrated for description. (On the contrary, of the components forming the cathode plate 601 in FIG. 2, only the electron-emitter elements 301 are illustrated). The inside space enclosed by the cathode plate 601, a phosphor plate 602, a frame component 603 is vacuum. To withstand the atmospheric pressure, spacers 60 are placed in the vacuum area. The shape, number, and placement of the spacers 60 are arbitrary. In FIG. 7, the thickness of the spacer 60 is shown larger than the width of the scan electrode 310 for the purpose of clarity of this figure, and the actual thickness of the spacer 60 is smaller than the width of the scan electrode 310. On the cathode plate 601, the scan electrodes 310 are placed in the horizontal direction, and data electrodes 311 are placed orthogonally thereto. Intersections between scan electrodes 310 and the data electrodes 311 correspond to pixels. Here, the pixel corresponds to a sub-pixel in a case of a color display apparatus.

In FIG. 7, the number of scan electrodes 310 is only 14, but is several hundreds to several thousands on an actual display. The number of data electrodes 311 on the actual display apparatus is also several hundreds to several thousands. At intersections between the scan electrodes 310 and the data electrodes 311, the electron-emitter elements 301 are placed.

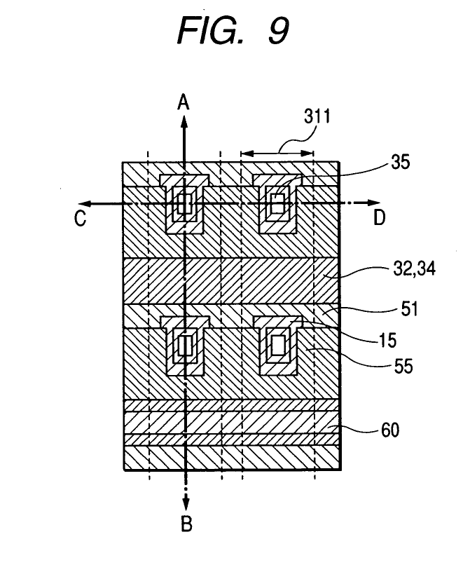

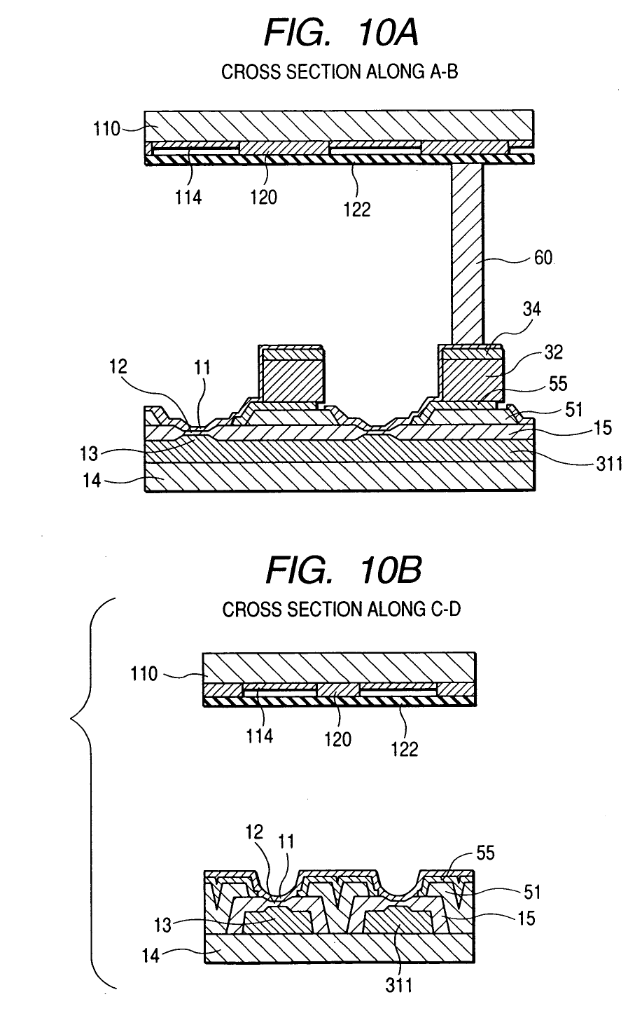

FIG. 9 is a plan view showing part of the cathode plate 601 (4 sub-pixels) in FIG. 7. FIGS. 10A and 10B are cross sections showing part of the cathode plate 601 in correspondence with FIG. 9. FIG. 10A is the cross section along A-B of FIG. 9, and FIG. 10B is the cross section along C-D of FIG. 9. FIG. 9 is the plan view with the top electrode 11 eliminated. As can be seen from the cross sections of FIGS. 10A and 10B, the top electrode 11 is actually deposited on the entire surface.

At a position corresponding to the respective sub-pixel, three-folded rectangular members are depicted. The innermost rectangular area denotes an electron-emission area 35, which corresponds to an innermost circumference of a tapered region (slope region) of a first inter-layer insulating film 15. The rectangular member on the outer side thereof corresponds to a perimeter of a taper film of the first inter-layer insulating film 15. The rectangular member on the outer side thereof (at the perimeter) is an opening of a second inter-layer insulator 51.

In this example, the scan electrode 310 is formed of a busline electrode 32. Moreover, in this example, the spacer 60 is set on the scan electrode 310. The spacer 60 does not have to be set on all the scan electrodes, and thus may be set on every several scan electrodes.

The spacer 60 is electrically connected to the scan electrode 310 and functions to cause a current to flow from an acceleration electrode 122 of the phosphor plate 602 via the spacer 60 and also functions to cause electrical charges charged on the spacer 60 to flow.

In this example, a thin-film electron emitter is used as the electron-emitter element 301. As shown in FIG. 10B, a base electrode 13, a tunneling insulator 12, and the top electrode 11 are basic components of the thin-film electron emitter. The electron-emission area 35 of FIG. 9 is a place corresponding to the tunneling insulator 12. From the surface of the top electrode 11 of the electron-emission area 35, electrons are emitted into the vacuum.

In this example, a partial region of the data line 311 (region in contact with the tunneling insulator 12) serves as the bottom electrode 13. In the present specification, of the data line 311, the portion in contact with the tunneling insulator 12 is called the base electrode 13.

The fabrication of the cathode plate 601 is as indicated below. On an insulating substrate 14 such as glass or the like, the thin-film electron emitter 301 (the electron-emitter elements 301 in this example) formed of the base electrode 13, the insulator 12, and the top electrode 11 is formed. A busline electrode 32 is electrically connected to the top electrode 11 with a contact electrode 55 in between. The busline electrode 32 functions as a feeding line toward the top electrode 11, that is, functions to carry a current from a drive circuit to the position of this sub-pixel. Moreover, in this example, the busline electrode 32 functions as the scan electrode 310.

In FIGS. 10A and 10B, the reduction scale in the height direction is arbitrary. Specifically, the base electrode 13, the top electrode, and the like have a thickness of several micrometers or less, while the distance between the substrate 14 and a front plate 110 is approximately 1 mm to 3 mm.

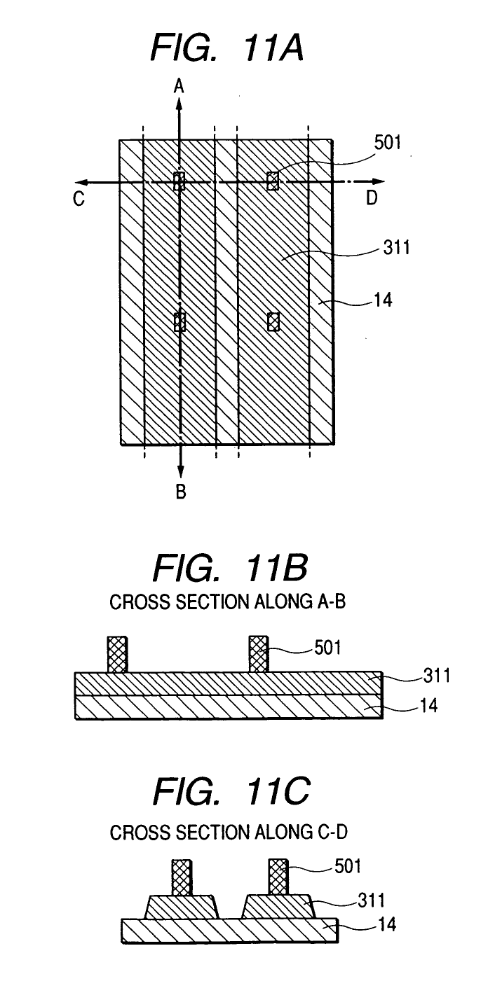

Method of fabricating the cathode plate 601 will be described with reference to FIGS. 11A to 11C through FIGS. 19A to 19C. FIGS. 11A to 11C through FIGS. 19A to 19C show processes of fabricating a thin-film electron emitter on the substrate 14. These figures show the thin-film electron emitter corresponding to 2×2 number of sub-pixels. In each of the figures, A is a plan view, B is a cross section along A-B, and C is a cross section along C-D.

On the insulating substrate 14 such as glass or the like, an Al alloy as a material for the base electrode 13 (data line 311) is formed into a film thickness of, for example, 300 nm. Here, an Aluminum-neodymium alloy is used. For the formation of this Al alloy film, for example, a sputtering method, a resistive-heating evaporation method, or the like is used. Next, this Al alloy film is processed by resist formation by way of photolithography and a following etching into a stripe-form to thereby form the base electrode 13. The resist used here may be the one suitable for etching. Etching may be achieved by either wet etching or dry etching.

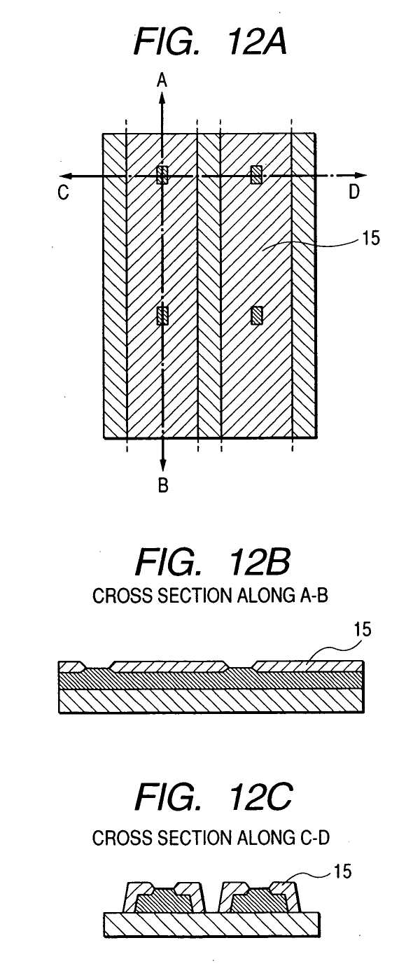

Next, pattern is formed by resist coating and then expose to ultraviolet-rays to thereby form resist patterns 501 of FIGS. 11A to 11C. As the resist, for example, a positive resist of quinonediazide-series is used. Next, with the resist pattern 501 kept fitted, anodization is performed to thereby form the first inter-layer insulating film 15. In the anodization in this example, the anodization voltage is approximately 100V, and the film thickness of the first inter-layer insulating film 15 is approximately 140 nm. After this anodization, the resist patterns 501 are removed, states of which are shown in FIGS. 12A to 12C.

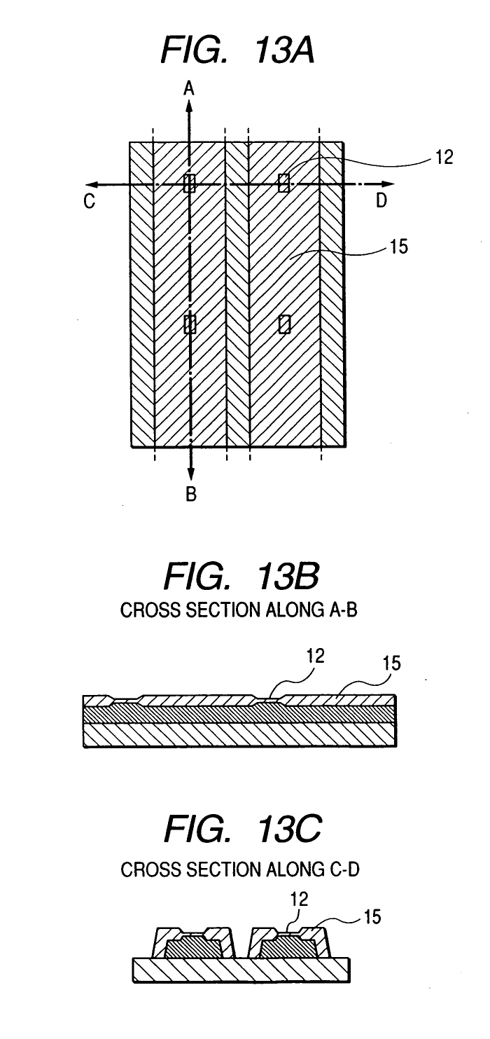

Next, the surface of the base electrode 13 which was covered by the resist 501 is anodized to thereby form the insulator 12. In this example, the anodization voltage is set at 6V, and the film thickness of the insulator is set at 10.6 nm, states of which are shown in FIGS. 13A to 13C. The area where the insulator 12 is formed serves as the electron-emission area 35. That is, the area surrounded by the first inter-layer insulating film 15 is the electron-emission area 35.

It has been conventionally reported that a film thickness d of an anodized insulating film obtained by anodizing aluminum has relationship, d (nm)=13.6×VAO, with an anodization voltage VAO. A recent study by the inventors showed that there exists relationship, d(nm)=13.6×(VAO+1.8), for a film thickness of approximately less than 20 nm (IEEE Transactions on Electron Devices, vol. 49, No. 6, pp. 1059-1065, 2002. [IEEE Transactions on Electron Devices, vol. 49, No. 6, pp. 1059-1065 (2002)]). The values described above (an anodization voltage of 6V, a film thickness of the insulator of 10.6 nm) are obtained form this latest relationship formula.

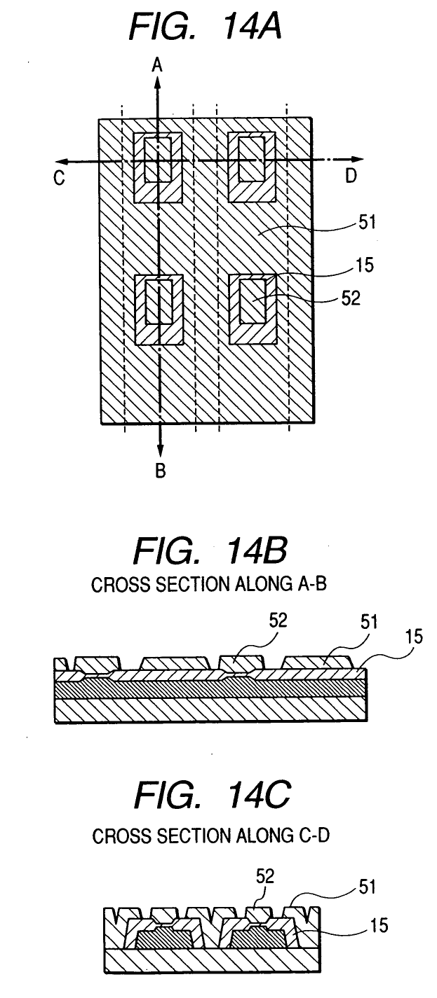

Next, with the following procedures, the second inter-layer insulator 51 and an electron-emission area protection layer 52 are formed (FIGS. 14A to 14C). The pattern of the second inter-layer insulator 51 is a pattern that covers an intersection area between the busline electrode 32 and the data electrode 311, and exposes the electron-emission area 35. However, in process steps of FIGS. 14A to 14C, the electron-emission area 35 is covered by the electron-emission area protection layer 52. The second inter-layer insulator 51 and the electron-emission area protection layer 52 are patterned by etching after silicon nitride SiNx, silicon oxide SiOx, or the like is deposited. In this example, a film of silicon nitride with a film the thickness of 100 nm is used. Etching is performed by dry etching which employs, for example, an etchant mainly composed of CF4 or SF6. The second inter-layer insulator 51 is formed to improve the insulation property between the scan electrode and the data electrode. The electron-emission area protection layer 52 is provided for the purpose of protecting a portion serving as the electron-emission area 35 (that is, the insulator 12) from process damage in the following processes; the electron-emission area protection layer 52 will be removed in a subsequent process as described later. In this example, the second inter-layer insulator 51 and the electron-emission area protection layer 52 are formed of the same material in the same process step.

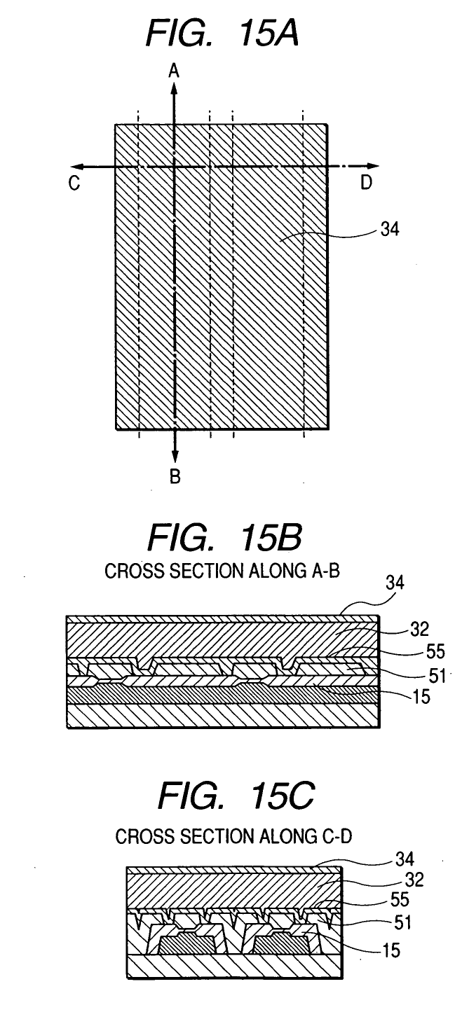

Next, materials forming the contact electrode 55, the busline electrode 32, and a busline electrode upper layer 34 are deposited in this order (FIGS. 15B and 15C). In this example, chromium (Cr) with a thickness of 100 nm is used for the contact electrode 55, aluminum (Al) with a thickness of 2 μm is used for the busline electrode 32, and chromium (Cr) with a thickness of 200 nm is used for the busline electrode upper layer 34. These electrodes are deposited by sputtering. The use of a material with high electrical conductivity for the busline electrode 32 results in low wiring resistance, preferably permitting reducing voltage drop along the electrode.

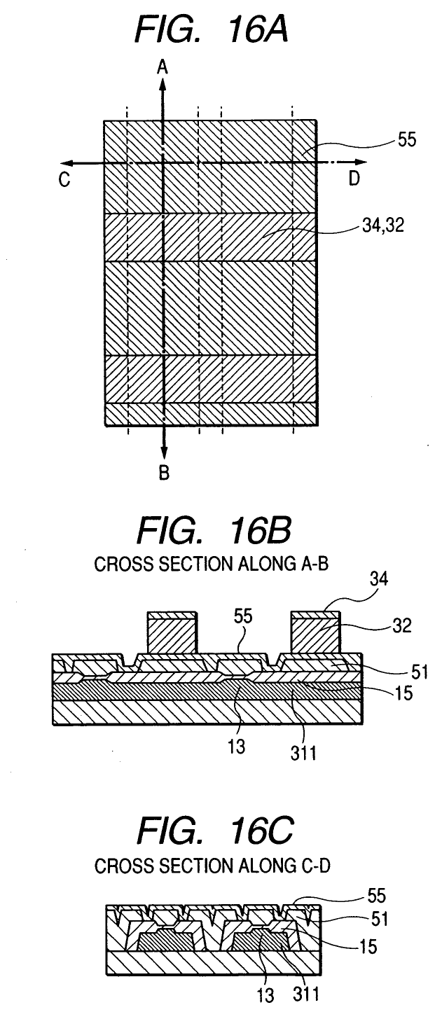

Next, the busline electrode upper layer 34 and the busline electrode 32 are patterned by etching, thereby, the contact electrode 55 is exposed so that the top electrode 11 can be connected to the contact electrode 55 later, thereby forming the busline electrode 32 (FIGS. 16B and 16C).

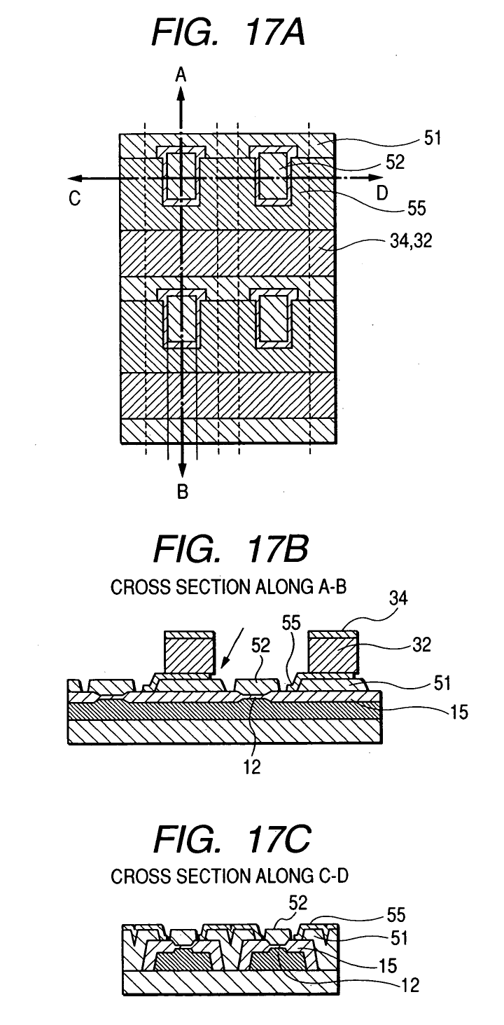

Next, the contact electrode 55 is patterned by etching (FIGS. 17A to 17C). Patterning the contact electrode 55 here determines a configuration of feeding from the contact electrode 55 to the electron-emission area 35.

As shown in FIG. 17A, the contact electrode 55 is so patterned as to extend along three sides of four sides of the electron-emission area 35. Providing such three-side feed structure improves the feeding capability.

As shown by an arrow in the cross section of FIG. 17B, one side of the contact electrode 55 (portion indicated by the arrow in the figure) forms undercut below the busline electrode 32, forming overhang for keeping the top electrode 11 electrically separated in a subsequent process. The presence of this undercut keeps mutual electrical insulation (separation) between the top electrodes of sub-pixels connected to adjacent scan lines. This is called “electrical separation between electron emission elements”.

The amount of undercut of the contact electrode 55 is controlled in the following manner.

For a portion where undercut is formed, the contact electrode 55 is etched by using a side of the busline electrode 32 as a photomask. Therefore, the contact electrode 55 generates undercut for the busline electrode 32. On the other hand, an excessive amount of undercut results in collapse of the busline electrode 32, bringing the busline electrode 32 and the second inter-layer insulator 51 into contact with each other, which in turn results in loss of the overhang. Thus, to prevent formation of this excessively large undercut, a material having a nobler standard electrode potential than a material of the busline electrode 32 is used for the contact electrode 55. That is, as the contact electrode 55, a material is used which is higher in the standard electrode potential than the material of the busline electrode 32. When the busline electrode is formed of aluminum, an example of such a material includes: for example, chromium (Cr), molybdenum (Mo), a Cr alloy, or an alloy including these elements as components, such as a molybdenum (Mo)-chromium (Cr)-nickel (Ni) alloy including as components, for example. Embodiments of the alloy include: a Mo—Cr—Ni alloy, and the like. Such a combination causes side etching of the contact electrode 55 to stop in the course of process due to local cell mechanism, thus preventing an excessive increase in the amount of undercut. Further, since the busline electrode is a material with a less noble (low) standard electrode potential, the local cell mechanism can be controlled by controlling the area of the busline electrode, the area of which is exposed to an etching reagent; thereby, it is possible to control the stop position (that is, the amount of undercut) of the side etching of the contact electrode 55. To this end, the busline electrode upper layer 34 of chromium (Cr) is formed.

As can be understood from the above, it is preferable to use for the contact electrode 55 a material which is a nobler (higher) in the standard electrode potential than the material of the busline electrode 32.

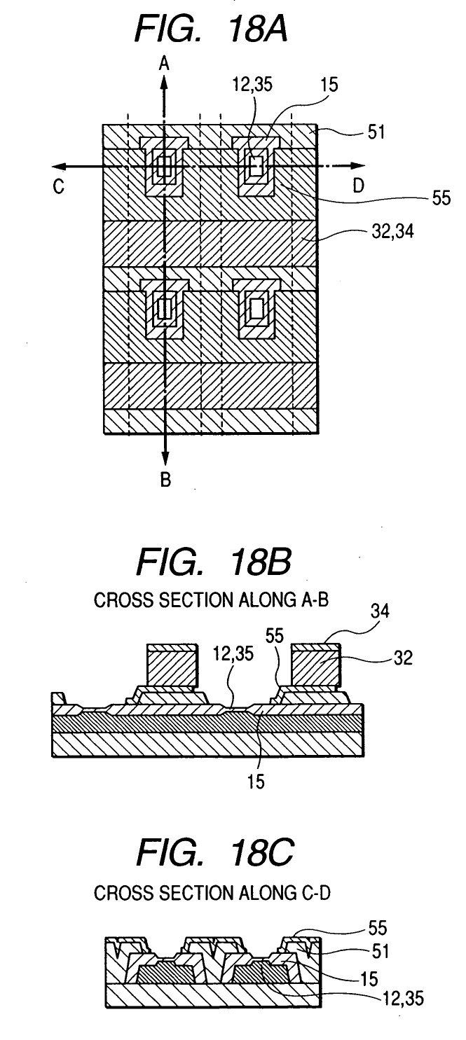

Next, the electron-emission area protection layer 52 is removed through dry etching and or the like (FIGS. 18A to 18C).

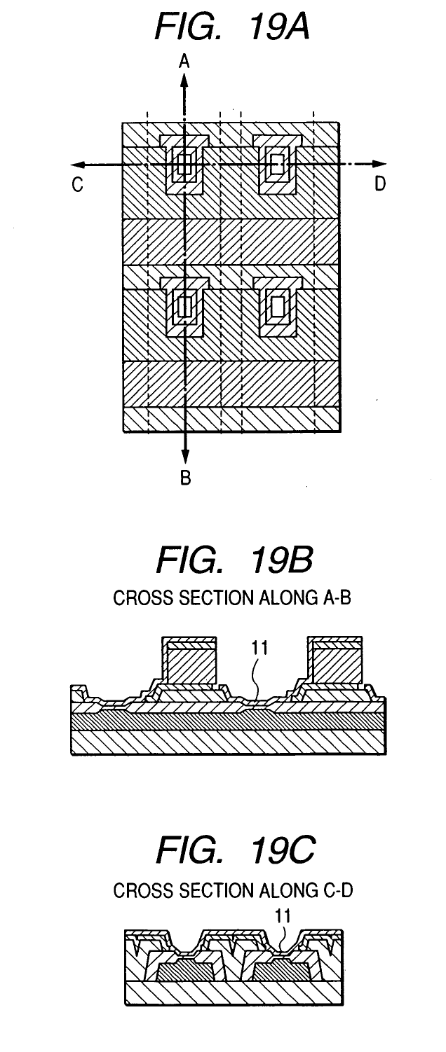

Next, the top electrode 11 is formed to complete the cathode plate 601 (FIGS. 19A to 19C). In this example, as the top electrode 11, a stacked film of iridium (Ir), platinum (Platinum), and gold (Au) is used. The top electrode 11 is formed by sputter deposition. The top electrode 11 is actually deposited on the entire surface, but for the purpose of easier understanding of the structure, the top electrode 11 is eliminated from FIG. 19A. Moreover, the position of the data lines 311 is indicated by dotted lines.

As shown in FIGS. 19A to 19C, a current is supplied from the busline electrode 32 as a feeding line to the top electrode 11 of the electron-emission area 35 via the contact electrode 55. On the other hand, as described above, an appropriate amount of undercut is formed at the contact electrode 55, so that the adjacent scan electrodes 310 are kept electrically insulated from each other.

In this example, a cathode structure is adopted which introduces two features including the feature A that three sides of the electron-emission area are used as a feed path from the busline electrode 32 to the top electrode 11 of the electron-emission area 35, and the feature B that a step of the second inter-layer insulator is eliminated from the feed path from the busline electrode to the top electrode of the electron-emission area.

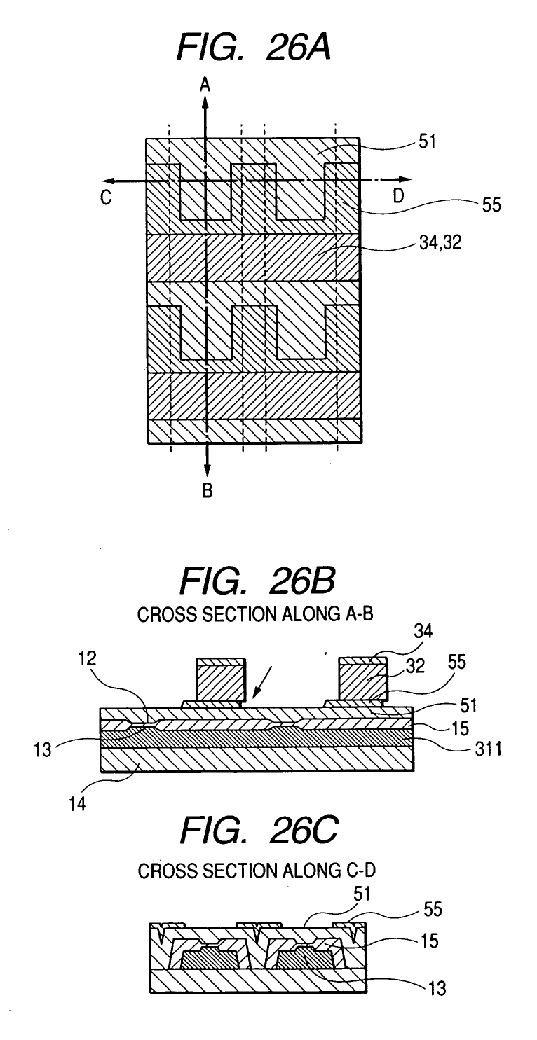

A cathode structure described in example 2 does not have the latter feature (feature B). That is, this structure is the same as a conventional structure in that the step of the second inter-layer insulator is included in the feed path. Now, manufacturing processes of the example 2 to be described later and manufacturing processes of the example 1 will be compared. As can be seen from FIGS. 16A to 16C, this example (that is, in which the feature B is included), prior to a patterning process of the contact electrode 55, the second inter-layer insulator 51 is patterned. On the other hand, as can be seen from FIGS. 26A to 26C, in the example 2, the process of patterning the contact electrode 55 is followed by the process of patterning the second inter-layer insulator 51. As can be seen by viewing the diagrams of manufacturing processes described in the example 1, patterning the second inter-layer insulator 51 prior to the patterning process of the contact electrode 55 is required to achieve the feature B that “the step of the second inter-layer insulator 51 is eliminated from the feed path”.

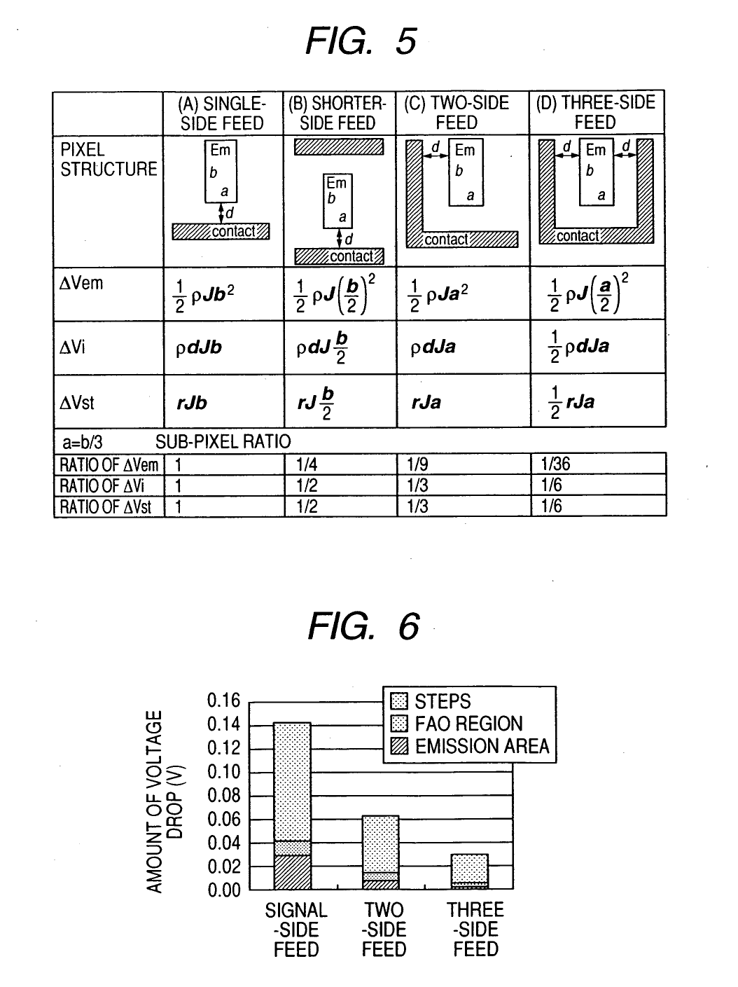

In the example 1, of the four sides of the electron-emission area 35, feeding is not performed from the side opposite to the electrically connected busline electrode 32. Thus, compared to a case where the entire electron-emission area 35 is used as the feed path, alignment margins (tolerance) of photo masks is wider, thus resulting in a structure that can be easily made. Moreover, as previously described in FIG. 5, a difference in the feeding capability between all-side feed and three-side feed excluding the short side is small, and thus this structure achieves both easy manufacturing and feeding capability.

The construction of the phosphor plate 602 will be described below. As shown in FIGS. 10A and 10B, a black matrix 120 is formed on a transparent front plate 110 of glass or the like, and further at position opposing each electron-emission area, a phosphor 114 is formed. In a case of a color display apparatus, as the phosphor 114, a red phosphor, a green phosphor, and a blue phosphor are painted separately from one another. Further, the acceleration electrode 122 is formed. The acceleration electrode 122 is formed of an aluminum film with a film thickness of approximately 70 nm to 100 nm. Electrons emitted from the thin-film electron emitter 301 is accelerated by an acceleration voltage which has been applied to the acceleration electrode 122, and then upon entering the acceleration electrode 122, are transmitted through the acceleration electrode to bombard the phosphor 114, and the phosphor emits light.

Details of fabricating the phosphor plate 602 are described in, for example, JP-A No. 2001-83907.

Between the cathode plate 601 and the phosphor plate 602, a suitable number of spacers 60 are placed. As shown in FIG. 7, the cathode plate 601 and the phosphor plate 602 are sealed to each other with the frame component 603 sandwiched therebetween. Further, the space enclosed by the cathode plate 601, the phosphor plate 602, and the frame component 603 is pumped to vacuum.

With the procedures described above, the display panel is completed.

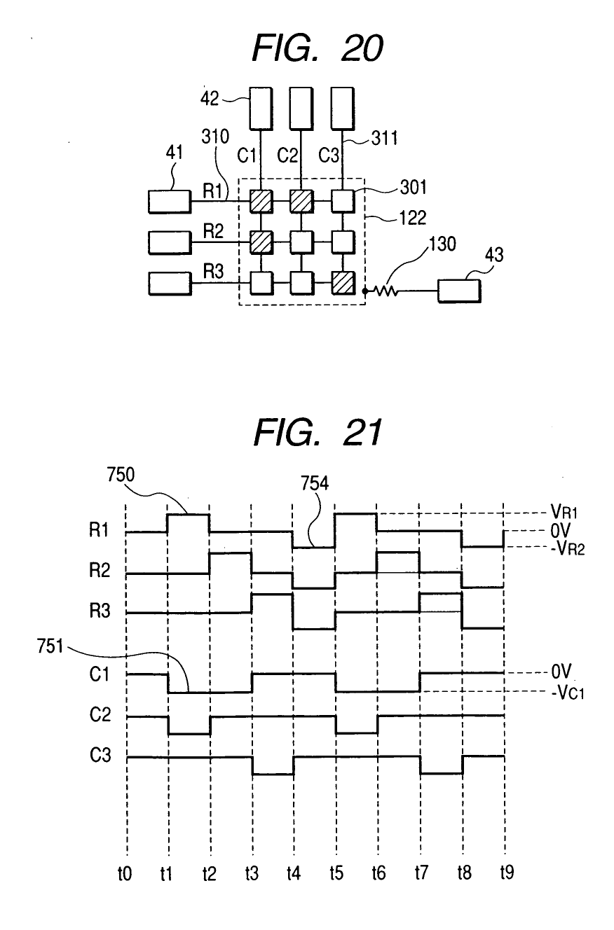

FIG. 20 is a diagram of wire connection to drive circuits of the display panel 100 manufactured as described above. The scan electrode 310 has wire connection to scan electrode drive circuits 41, and the data electrode 311 has wire connection to data electrode drive circuits 42. The acceleration electrode 122 has wire connection to an acceleration electrode drive circuit 43 via a resistor 130. A dot at the intersection between the n-th scan electrode 310 Rn and the m-th data electrode 311 Cm is represented by (n,m).

The resistance value of the resistor 130 is set as follows. For example, in a display apparatus with a diagonal size of 51 cm (20 inches), the display area is 1240 cm². When the distance between the acceleration electrode 122 and the cathode is set at 2 mm, a capacitance Cg between the acceleration electrode 122 and the cathode is approximately 550 pF. To provide a time constant, for example 500 nanoseconds, sufficiently longer than the occurrence time duration of vacuum discharge (approximately 20 nanoseconds), a resistance value Rs of the resistor 130 may be set equal to 900Ω or more, and is set at 18 KΩ in this example (time constant 10 μs). Inserting between the acceleration electrode 122 and the acceleration electrode drive circuit 43 a resistor having a resistance value satisfying “time constant Rs×Cg>20 ns” in this manner is effective in suppressing the occurrence of vacuum discharge in the display panel.

FIG. 21 shows waveforms of voltages generated in the respective drive circuits. Although not indicated in FIG. 21, to the acceleration electrode 122, a voltage of approximately 3 to 10 KV (phosphor screen voltage Va) is applied.

At a time t0, any of the electrodes has zero voltage, so that no electrons are emitted and thus the phosphor 114 does not emit light.

At a time t1, a scan pulse 750 with a voltage VR1 is applied to the scan electrode 310 R1, and a data pulse 751 with a voltage −VC1 is applied to the data electrodes 311 C1 and C2. Between the base electrode 13 and the top electrode indicated by dots (1,1) and (1,2), respectively, a voltage (VC1+VR1) is applied, and thus setting the (VC1+VR1) equal to or larger than the threshold voltage for electron emission causes electrons to be emitted from the thin-film electron emitter indicated by these two dots into the vacuum 10. In this example, VR1=+5V and VC1=−4V. The emitted electrons are accelerated by a voltage applied to the acceleration electrode 122 and then bombards the phosphor 114, thus causing the phosphor 114 to emit light.

At a time t2, when a voltage VR1 is applied to the scan electrode 310 R2 and a voltage −VC1 is applied to the data electrode 311 C1, a dot (2,1) is turned on in the same manner. The application of the voltage waveforms of FIG. 21 in this manner turns on only dots provided with diagonal lines of FIG. 20.

Changing a signal applied to the data electrode 311 as described above permits displaying a desired image or information. Moreover, appropriately changing the amplitude of the voltage −VC1 applied to the data electrode 311 in accordance with an image signal permits displaying an image with gray scale.

As described in FIG. 21, at a time t4, a voltage −VR2 is applied to all the scan electrodes 310. In this example, −VR2=−5V. In this condition, the voltage applied to all the data electrodes 311 is 0V, and thus a voltage of −VR2=−5V is applied to the thin-film electron emitter 301. The application of a voltage (reverse pulse 754) with a reverse polarity with respect to the polarity upon electron emission in this manner liberates charges accumulated in traps in the insulator 12, and thus can improve lifetime characteristics of the thin-film electron emitter. Moreover, as a period during which a reverse pulse is applied (t4 to t5 and t8 to t9 in FIG. 21), a vertical blanking period of a video signal is used, resulting in favorable matching with the video signal.

The description of FIGS. 20 and 21 is given, referring to an example of 3×3 dots for simplification, but an actual display apparatus has several hundreds to several thousands of scan electrodes and several hundreds to several thousands of data electrodes.

In the display apparatus manufactured as described above, a display panel is fabricated with a different film thickness of the top electrode, and the electron emission ratio thereof is measured, the results of which are shown in FIG. 32. As a physical quantity representing the film thickness of the top electrode, a sheet resistance of the top electrode is used. A thinner film thickness results in a higher sheet resistance.

As shown in FIG. 32, providing a sheet resistance of 1 kilo ohm per square provides an electron emission ratio of as high as 1.4%, which exceeds 1%. When the top electrode is provided with a sheet resistance further increased to 11 kilo ohm per square (that is, made thinner), the electron emission ratio reaches 4.9%. In FIG. 32, as a diode voltage (voltage applied between the top electrode and the base electrode) Vd, corresponds to a value measured with a relatively low voltage of 8V. Increasing the Vd to 9V resulted in an even higher electron emission ratio. As described above, a high electron emission ratio is obtained even with a relatively low Vd as described above.

With a conventional cathode structure, increasing the sheet resistance results in insufficient capability of feeding from the busline electrode to the top electrode, thus leading to failure to make the top electrode thinner to a thickness corresponding to a sheet resistance of 1 kilo ohm per square or more. On the contrary, employed in the present invention are a structure which uses three sides of the electron-emission area as the feed path from the busline electrode to the top electrode of the electron-emission area and also a structure in which the step of the second inter-layer insulator is eliminated from the feed path from the top busline electrode to the top electrode of the electron-emission area. This improves the capability of feeding from the busline electrode to the top electrode, thus permitting sufficient feeding to the electron-emission area 35 even with the top electrode with a sheet resistance of 11 kilo ohm per square, which in turn, as shown in FIG. 32, permits achieving a high electron emission ratio.

A diode current density Jd required to obtain a certain emission current density Je is Jd Je/α where α is an electron emission ratio. Therefore, an increase in the electron emission ratio decreases a diode current density required to obtain the same emission current density (that is, to obtain the same luminance).

A decrease in the diode current density decreases the drive power of the electron-emitter element, thus obtaining a display apparatus with low power consumption accordingly. Moreover, a decrease in the drive current decreases a required drive current of the drive circuit, thus providing a low-cost display apparatus. Further, a current caused to flow to the electrode decreases, thus improving the reliability of the electrode.

In the present invention, the busline electrode 32 required to have a large electrode film thickness to achieve lower resistance of electrode wiring is shaped into a wiring pattern of a stripe-form, thus permitting easy formation of an electrode with a large film thickness. On the other hand, the contact electrode 55, which requires pattern alignment in two directions including the longitudinal direction and the lateral direction, is thinner (typically 50 nm to 500 nm thick) than the busline electrode and thus can be easily patterned. Separate use between a stripe-form and a non-stripe form in accordance with the film thickness as described above permits improving manufacturability of an electron-emitter element having a high performance, thus obtaining a high manufacturing yield.

In the present invention, the edge of the electrode group (data electrode 311) orthogonal to the busline electrode is double covered with the first inter-layer insulating film 15 and also with the second inter-layer insulator 51. Since the anodization film at the edge of the electrode is a place where short-circuit failure is likely to occur due to the generation of a pinhole or the like, covering it with the second inter-layer insulator prevents occurrence of such short-circuit failure, thus permitting an improvement in the manufacturing yield.

### Embodiment 2

In this example, a display apparatus will be described which is of a three-side feed type as is the case with the example 1 but employs a cathode structure that a top electrode climbs up steps at the edge of a second inter-layer insulator. That is, this example refers to the display apparatus employing a cathode structure that the top electrode covers the steps at the edge of the second inter-layer insulator. In another word, in the cathode structure, there is a step of the second inter-layer insulator along the feed path extending from the busline electrode to the top electrode on the electron-emission area.

Plan views of a display panel for use in this example are shown in FIGS. 7 and 8. Description of these figures is as described referring to the example 1.

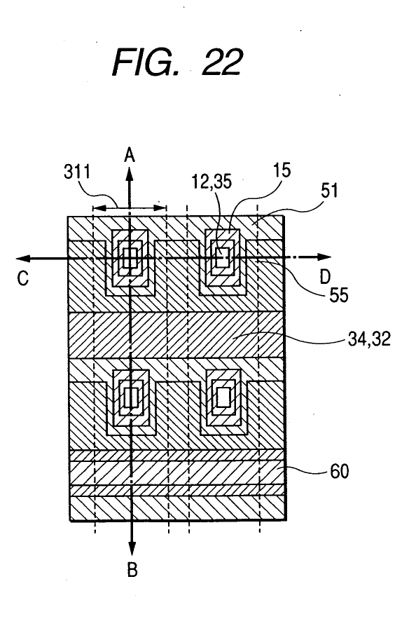

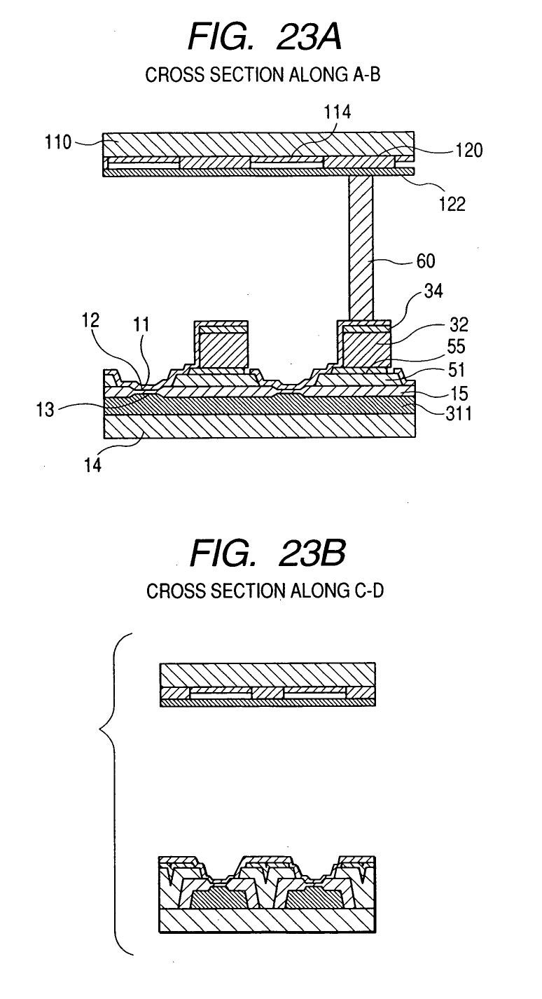

FIG. 22 is a plan view showing part of the cathode plate 601 in FIG. 7. FIGS. 23A and 23B are cross sections showing part of the cathode plate 601 in correspondence with FIG. 22. FIG. 23A is the cross section along A-B of FIG. 22, and FIG. 23B is the cross section along C-D of FIG. 22. FIG. 22 is the plan view with the top electrode 11 eliminated. As can be seen from the cross sections shown in FIGS. 23A and 23B, the top electrode 11 is deposited on the entire surface.

In FIG. 22, rectangles at portions corresponding to respective sub-pixels are formed in order from the inner side as described below. Located on the innermost side is an electron-emission area 35 which is on the inner side of a tapered-region (slope region) of a first inter-layer insulating film 15. The second rectangle is located on the outer side of the tapered-region of the first inter-layer insulating film 15. Further on the outer side thereof, a region where the first inter-layer insulating film 15 is exposed is located (on the top thereof, the top electrode 11 is deposited). Located on the outer side thereof is a region where a second inter-layer insulator 51 is formed.

FIGS. 22 and 23A and 23B differ from FIGS. 9 and 10 in the positional relationship between the contact electrode 55 and an opening of the second inter-layer insulator 51.

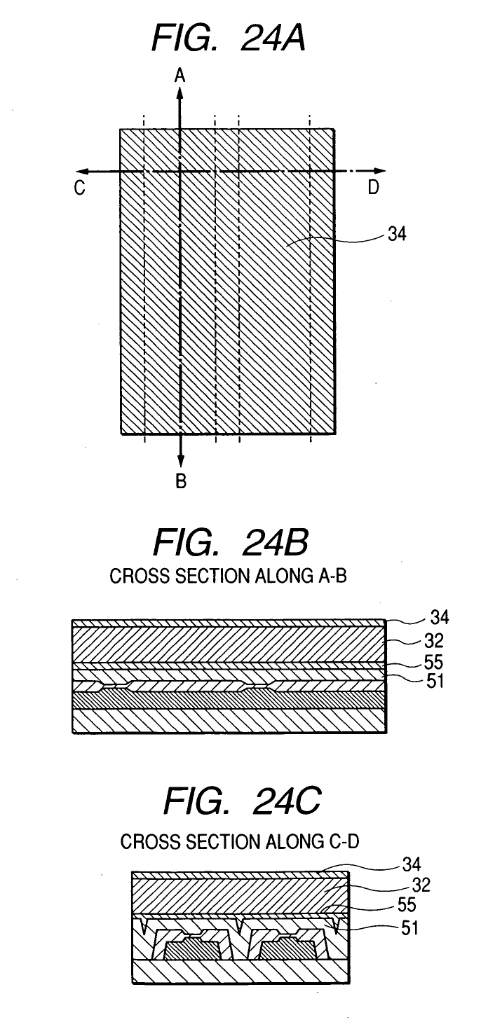

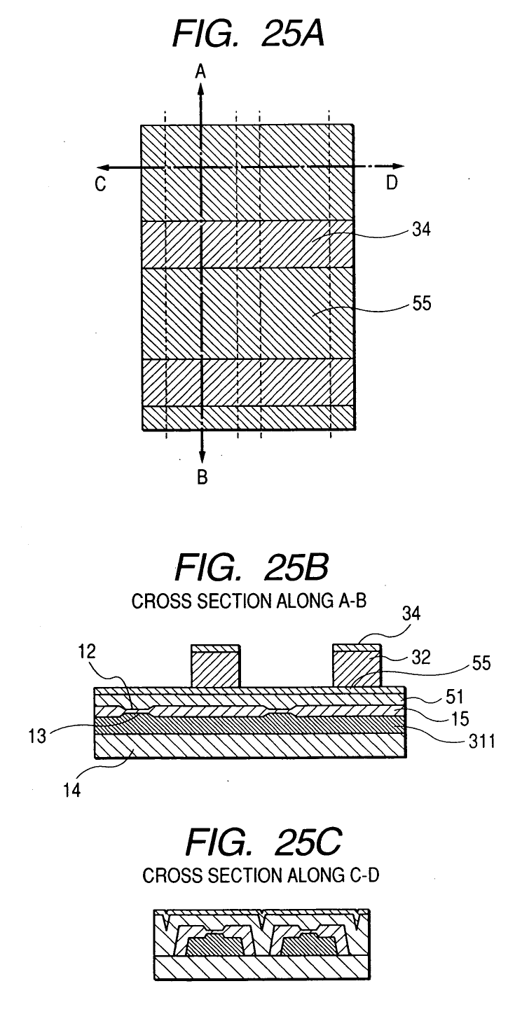

A method of fabricating the cathode plate 601 will be described with reference to FIGS. 11A to 11C through FIGS. 13 A to 13C, and FIGS. 24A to 24C through FIGS. 28A to 28C. FIGS. 11A to 11C through FIGS. 13A to 13C and FIGS. 24A to 24C through FIGS. 28A to 28C show processes of fabricating a thin-film electron emitter on the substrate 14. These figures describe the thin-film electron emitter formed of 2×2 sub-pixels. FIGS. 24A, 25A, 26A, 27A, and 28A are plan views, FIGS. 24B, 25B, 26B, 27B, and 28B show cross sections along A-B, and FIGS. 24C, 25 C, 26 C, 27C, and 28C show cross sections along C-D.

Description of FIGS. 11A to 11C through FIGS. 13A to 13C is as already described referring to the example 1.

Next, as shown in FIGS. 24A to 24C, materials forming the second inter-layer insulator 51, the contact electrode 55, a busline electrode 32, and a busline electrode upper layer 34 are deposited (FIGS. 24A to 24C). As can be seen from FIG. 22, in this example, the contact electrode is located at an upper side (vacuum side) than the second inter-layer insulator 51. Therefore, as shown in FIGS. 24B and 24C, the materials of the second inter-layer insulator 51, the contact electrode 55, the busline electrode 32, and the busline electrode upper layer 34 are all once deposited and then the layers are sequentially patterned by etching in the reverse order.

For the second inter-layer insulator 51, a material, such as silicon nitride SiNx, silicon oxide SiOx, or the like is used. In this example, a silicon nitride film with a film thickness of 100 nm is used. The second inter-layer insulator 51 is formed for the purpose of improving the insulation property between the scan electrode 310 and the data electrode 311.

In this example, chromium (Cr) with a thickness of 100 nm is used for the contact electrode 55, aluminum (Al) with a thickness of 2 μm is used for the busline electrode 32, and chromium (Cr) with a thickness of 200 nm is used for the busline electrode upper layer 34. Use of a material having high electrical conductivity as a material for the busline electrode 32 provides low wiring resistance, thus preferably permitting reduction in voltage drop on the electrode.

Next, the busline electrode upper layer 34 and the busline electrode 32 are patterned by etching to thereby form the busline electrode 32 (FIGS. 25A to 25C).

Next, the contact electrode 55 is patterned by etching (FIGS. 26A to 26C).

As shown in FIG. 26A, the contact electrode 55 is so patterned as to extend along three of four sides of the electron-emission area 35. Providing such three-side feed structure as described above improves the feeding capability.

As shown by an arrow in the cross section of FIG. 26B, one side of the contact electrode 55 (portion indicated by the arrow in the figure) forms undercut for the busline electrode 32, forming overhang for making the top electrode 11 electrically separated in a later process. The presence of this undercut keeps mutual electrical insulation (separation) between top electrodes of sub-pixels connected to adjacent scan lines. This is called “electrical separation between electron emission elements”. A method of controlling the amount of undercut of the contact electrode 55 is as described referring to the example 1.

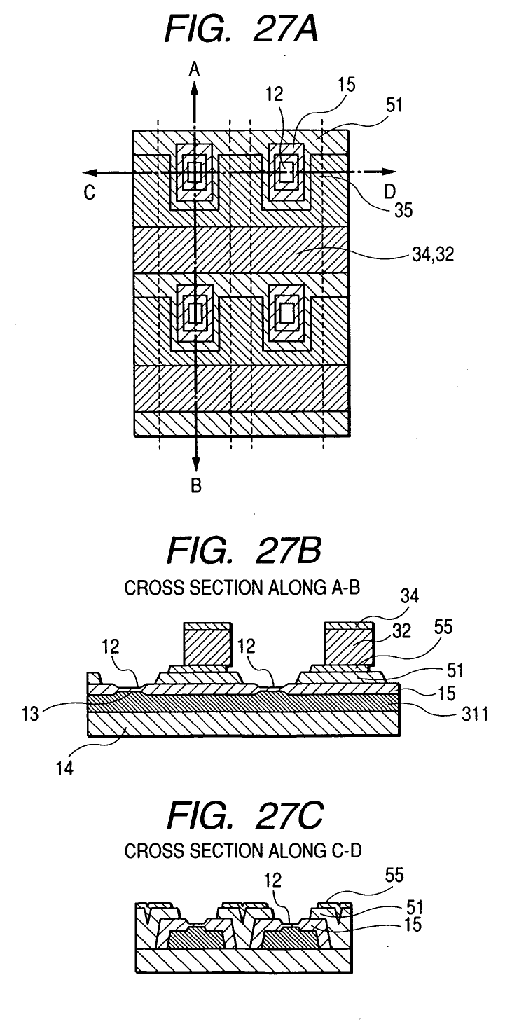

Next, the second inter-layer insulator 51 is processed into the shape of FIGS. 27A to 27C. Etching is performed by dry etching which uses, for example, an etchant of CF4 or SF6 as a main component.

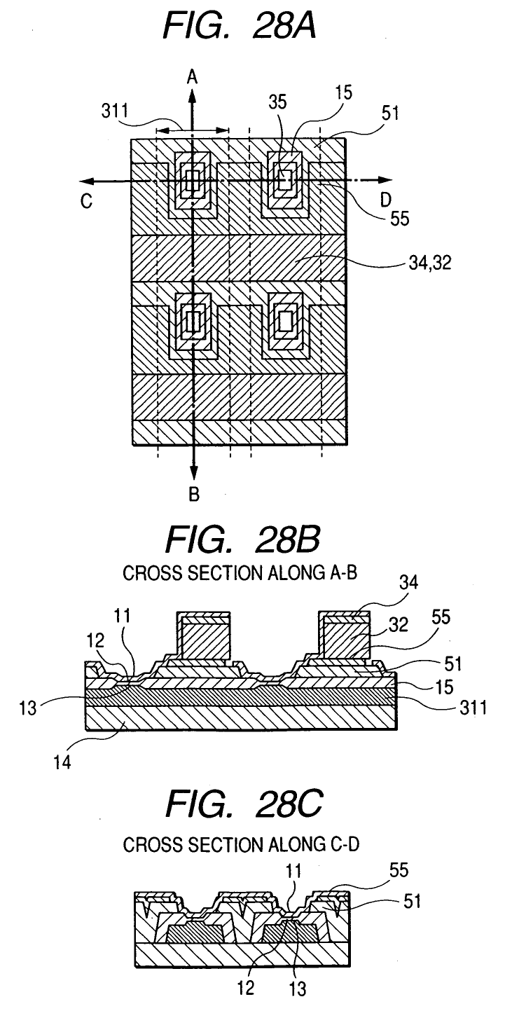

Next, the top electrode 11 is formed to complete the cathode plate 601 (FIGS. 28A to 28C). In this example, as the top electrode 11, a stacked film of iridium (Ir), platinum (Platinum), and gold (Au) is used, and formed to have a film thickness corresponding to a sheet resistance of 1 kilo ohm per square. The top electrode 11 is formed by spatter deposition.

In the plan view of FIG. 28A, the top electrode 11 is actually deposited on the entire surface, but for the purpose of easier understanding of the construction, the top electrode 11 is eliminated from FIG. 28A. Moreover, the position of data lines 311 is indicated by dotted lines.

As shown in FIGS. 28A to 28C, a current is supplied from the busline electrode 32 as a feeding line to the top electrode 11 of the electron-emission area 35 via the contact electrode 55. On the other hand, as described above, an appropriate amount of undercut is formed at the contact electrode 55, so that the adjacent scan electrodes 310 are kept electrically insulated from each other.

In this example, as can be seen from the cross section of FIG. 28B, the contact electrode 55 does not cover the edge of the second inter-layer insulator 51 facing the electron-emission area, there is a step of the second inter-layer insulator 51 on an electrical path leading from the contact electrode 55 to the top electrode 11 of the electron-emission area 35. The second inter-film insulating layer 51 has a film thickness of approximately 100 nm, which is larger than the film thickness of the top electrode 11 (several nm to several tens nm), so that the resistance of the top electrode 11 is likely to be high at the step of the second inter-layer insulator 51, thus causing deterioration in the feeding capability. However, in this example, since the contact electrode 55 faces three sides of the electron-emission area, the feeding capability is higher than the conventional structure. Thus, the film thickness of the top electrode 11 can be made thinner than that of the conventional structure, thus providing high electron emission efficiency.

The film thickness of the first inter-layer insulating film 15 is 140 nm in this example, which is similar thickness to that of the second inter-layer insulator 51. However, in this example, the first inter-layer insulating film 15 is formed by anodization. Use of this formation method results in an extremely gentle shape of a transition region (step) reaching from the insulator 12 (with a film thickness of approximately 10 nm in this example) to a film thickness of 140 nm, a film thickness of the first inter-film layer insulating layer 15. Thus, even for a top electrode with a film thickness of approximately several nm to 10 nm, a step of the first inter-layer insulating film has little influence on the feeding capability.

Also in this example, the second inter-layer insulator 51 is inserted not only between the layers at cross points of the scan electrodes 32 and the data electrodes 311 but also at all points between the layers at cross points of the contact electrodes 55 and the data electrodes 311. Thus, this provides advantage that short-circuit failure between the scan electrodes 32 and the data electrodes 311 is extremely less likely to occur.

Moreover, as can be seen from FIGS. 24A to 24C, the second inter-layer insulator 51, the contact electrodes 55, the busline electrodes 32, and the busline electrode upper layer 34 are collectively (without undergoing a patterning process) deposited, which provides advantage that state of the interface between the second inter-layer insulator 51 and the contact electrodes 55 can be kept fixed easily, resulting in easy machining.

In the processes described above, the cathode plate 601 is completed. A method of fabricating the phosphor plate 602 and procedures of fabricating a display panel by combining together the cathode plate and the phosphor plate are the same as those in the example 1.

A method of wire connection of a display panel to drive circuits is described in FIG. 20. This has been also described referring to the example 1. Moreover, FIG. 21 shows waveforms of voltage generated in the respective drive circuits. This driving method has been also described referring to the example 1.

In the example 2, the construction of a three-side feed type display apparatus has been described. This structure provides the same effect, if it combined with, for example, two-side feed type construction as in the fourth example to be described later. In the two-side feed type structure of the example 2, of sides of the electron-emission area, the adjacent two sides, one of which is the longest side, are provided as feed sides, so that the feeding capability with this structure is higher than that with the conventional structure.

### Embodiment 3

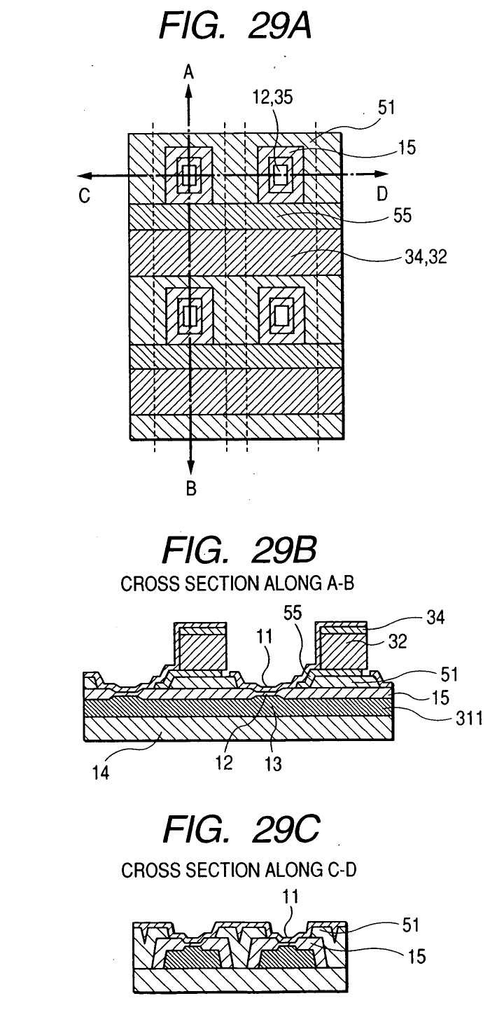

FIGS. 29A to 29C are diagrams showing the construction of a cathode plate 601 in the example 3 according to the present invention. FIG. 29A is a plan view of the cathode plate 601, FIG. 29B is a cross section thereof along A-B, and FIG. 29C is a cross section thereof along C-D. In the plan view of FIG. 29A, a top electrode 11 is actually deposited on the entire surface, but for the purpose of easier understanding of the construction, the top electrode is eliminated from FIG. 29A. Moreover, the position of the data lines 311 is indicated by dotted lines.

The cathode plate 601 shown in FIG. 29 can be fabricated in the same process as the cathode plate of the first example.

Moreover, a method of fabricating a display panel using the cathode plate shown in FIG. 29 and a driving method of wire connection with the drive circuit are same as those in the first example.

In this example, only one side of the electron-emission area faces the contact electrode 55, and thus the feeding capability is poorer than is achieved with construction of a three-side feed type. On the other hand, as can be seen from the cross section of FIG. 29B, as is with FIG. 19B, the contact electrode 55 covers the edge of the second inter-layer insulator 51, there is no edge (step) of the second inter-layer insulator 51 in the middle of a path communicating from the contact electrode 55 to the electron-emission area 35. Due to the latter construction, higher feeding capability than that in conventional construction of a cathode plate can be achieved, thus permitting the top electrode 11 to be formed into a thin film, thereby providing high electron emission efficiency.

The characteristic of this example, as can be seen from FIG. 29A, lies in that not only the busline electrodes 32 but also the contact electrodes 55 are shaped into a stripe-form. Thus, alignment margin (design-rule margin) in the horizontal direction between photo masks of each layer is wide, thus providing advantage that manufacturing is achieved with low required accuracy of fabrication. In another word, a higher-resolution display apparatus can be fabricated by an apparatus having the same machining accuracy.

### Embodiment 4

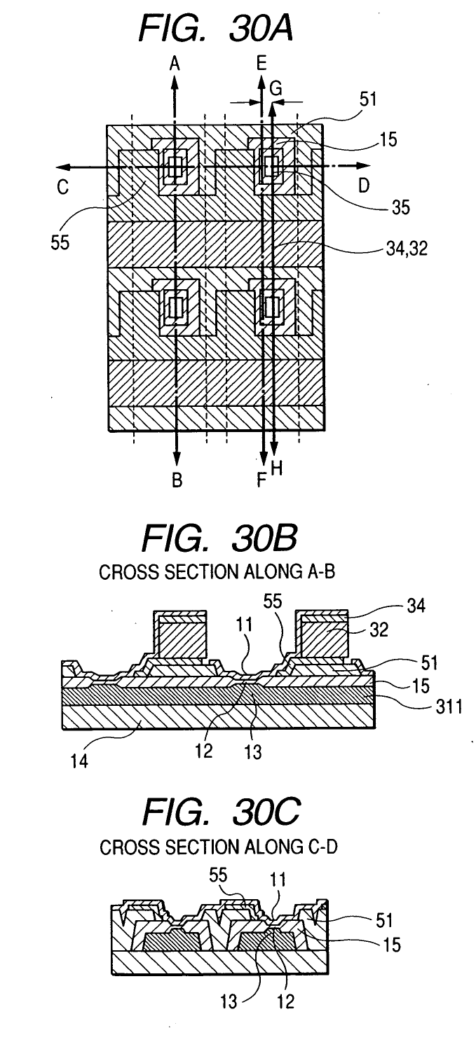

FIGS. 30A to 30C are diagrams showing the construction of the cathode plate 601 in the fourth embodiment according to the present invention. FIG. 30A is a plan view of the cathode plate 601, FIG. 30B is a cross section along A-B, and FIG. 30C is a cross section along C-D. In the plan view of FIG. 30A, the top electrode 11 is actually deposited on the entire surface, but for the purpose of easier understanding of the construction, the top electrode is eliminated from FIG. 30A. Moreover, the position of the data lines 311 is indicated by dotted lines.

The cathode plate 601 shown in FIGS. 30A to 30C can be fabricated in the same processes as those used for the cathode plate of the example 1.

Moreover, a method of fabricating a display panel using the cathode plate shown in FIGS. 30A to 30C and a method of wire connection with drive circuits, and a driving method are the same as those in the example 1.

In this example, two-side feed structure is employed in which adjacent two sides of an electron-emission area 35 face a contact electrode 55. As described above, it is important for improving the feeding capability that the longer side of the electron-emission area 35 faces the contact electrodes 55.

In the structure of FIGS. 30A to 30C, the center line of the electron-emission area 35 (line G-H in the figure) is shifted (displaced) from the center line of the data line 311 (line E-F in the figure). Such displacement, as described later, increases the alignment margins of photo masks (tolerance) and the design-rule margin, thereby permitting manufacturing with lower required accuracy of fabrication. Conversely, a higher-resolution display apparatus can be built by using the same accuracy of fabrication.

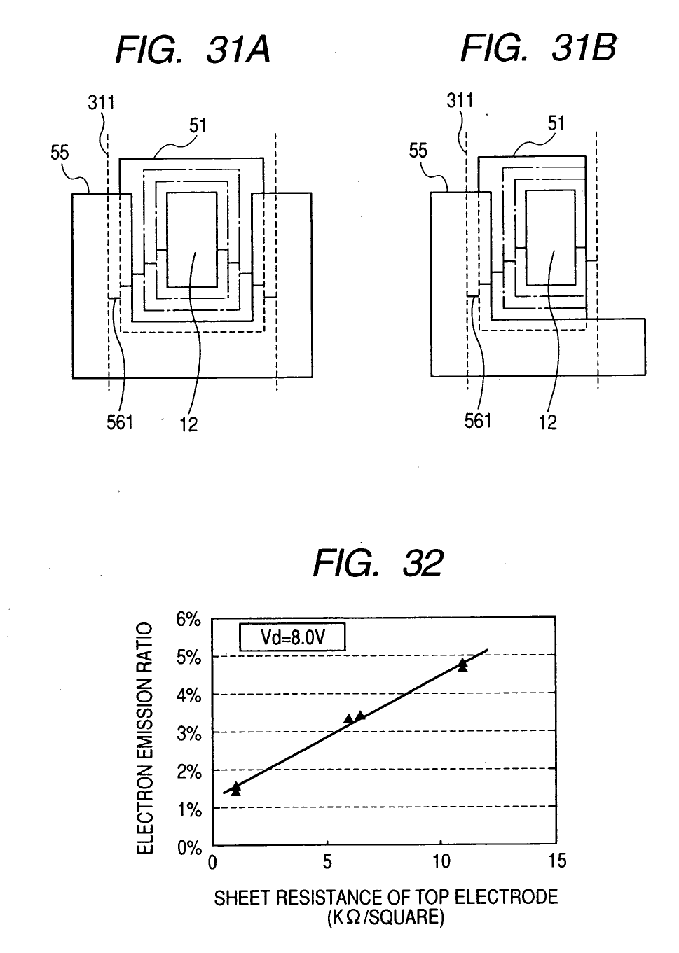

FIG. 31 is a diagram describing comparison of the mask alignment margin between the structure of the example 1 and the structure of FIGS. 30A to 30C. FIG. 31 is intended to describe the alignment margin in the lateral direction, and thus the scan line 32 and the like are omitted from illustration. Indicated by dashed lines are position of patterns which are required in the fabrication processes but finally disappear, more specifically, an electron-emission area protection layer 52 (FIG. 14B), that is, a film which protects the electron-emission area and comprises of a portion of a second inter-layer insulating film, and a resist pattern used for removing the electron-emission area protection layer 52. In the figure, numeral 51 denotes an opening of the second inter-layer insulator 51. For the purpose of simplified description, the maximum alignment error between masks is provided as a length D (indicated by short horizontal lines 561 in the figures). It can be seen from the figures that the maximum alignment error of the entire mask is 10D for the structure A of the three-side feed type and 7D for the structure B of this example. For example, where D=10 μm, the maximum alignment error decreases by 3D=30 μm with the structure B. In another word, the alignment margin in the lateral direction (design-rule margin) increases by 3D=30 μm. A color display apparatus has sub-pixels (corresponding to emission points of red, blue, and green) so formed as to usually have a length-breadth ratio of 3:1 and have a narrower width in the horizontal direction. The pitch of sub-pixels in the horizontal direction is typically 150 to 100 μm for a display apparatus. Therefore, an increase of 3D in the design margin in the horizontal direction provides advantage of easy manufacturing. Moreover, when built with the same accuracy of fabrication, a higher-definition display apparatus can be achieved.

Moreover, as can be seen from the cross section of FIG. 30B, as in FIG. 19B, since the contact electrode 55 covers the edge of the second inter-layer insulator 51, there is no edge (step) of the second inter-layer insulator 51 on a path leading from the contact electrodes 55 to the electron-emission area 35. Use of this structure in addition to adoption of the two-side feed structure including a longer side provides even higher feeding capability. This therefore permits the thickness of the top electrode 11 to be made thinner, providing high electron emission efficiency. As described above, the structure shown in this example, that is, the structure of a two-side feed type in which the contact electrode extends along the two sides, including the long side, of the electron-emission area and also of an offset type in which the electron-emission area is shifted from the center of the data line is suitable for achieving favorable balance between high feeding capability and high definition.

It is important that the edge of the data line is covered by the second inter-layer insulator 51, which applies to both FIGS. 31A and 31B. This permits reducing occurrence of short circuit between the data line and the scan line, because short circuit is likely to occur at the step (edge) of the data line and thus this portion can be double-insulated by the second inter-layer insulator 51 and the first inter-layer insulator to thereby reduce the occurrence of short circuit.

What is claimed is:

1. A display apparatus comprising:
a cathode plate having: a plurality of thin-film electron emitters which have a base electrode, a top electrode, and an electron acceleration layer sandwiched between the base electrode and the top electrode and which emits electrons from a top electrode side by applying a voltage between the base electrode and the top electrode; a plurality of first electrode groups parallel to one another; and a plurality of second electrode groups parallel to one another, the first electrode groups being configured to feed power to the top electrode;
a display panel having a phosphor screen substrate having a phosphor screen where a phosphor is formed which is excited by the electrons to emit light; and
a drive circuit which drives the thin-film electron emitters,
wherein each electrode (first electrode) forming the first electrode group is in a stripe-form,
wherein a contact electrode electrically connected to the first electrode is provided which is electrically connected to the top electrode and provided along two or more adjacent sides of the electron-emission area of the thin-film electron emitter.

2. The display apparatus according to claim 1,
wherein a film thickness of the contact electrode is smaller than a film thickness of the first electrode but larger than a film thickness of the top electrode.

3. The display apparatus according to claim 1,
wherein the contact electrode is connected to the first electrode on a side of the contact electrode,
wherein, on a side opposite to the side of the first electrode, undercut is formed below the first electrode.

4. The display apparatus according to claim 1
wherein the contact electrode is in contact with a plurality of sides excluding a side opposite to the first electrode electrically connected to the thin-film electron emitter.

5. The display apparatus according to claim 1,
wherein the two or more adjacent sides include the longest side of sides of the electron-emission area of the thin-film electron emitter.

6. The display apparatus according to claim 1,
wherein the two or more adjacent sides include, of the sides of the electron-emission area of the thin-film electron emitter, a side in a direction perpendicular to a direction of the first electrode group.

7. The display apparatus according to claim 1,
wherein a center of the electron-emission area is displaced from a center line of each electrode of the second electrode group.

8. The display apparatus according to claim 1,
wherein sheet resistance of the top electrode is 1 kilo-ohm per square or more.

9. The display apparatus according to claim 1,
wherein the contact electrode is provided at a layer between a layer of the first electrode group and a layer of the second electrode group.

10. A display apparatus comprising:
a cathode plate having: a plurality of thin-film electron emitters which have a base electrode, a top electrode, and an electron acceleration layer sandwiched between the base electrode and the top electrode and which emits electrons from a top electrode side by applying a voltage between the base electrode and the top electrode; a plurality of first electrode groups parallel to one another; and a plurality of second electrode groups parallel to one another, the first electrode groups being configured to feed power to the top electrode;
a display panel having a phosphor screen substrate having a phosphor screen where a phosphor is formed which is excited by the electrons to emit light; and
a drive circuit which drives the thin-film electron emitters,
wherein the first electrode group is electrically connected to a contact electrode, which is electrically connected to the top electrode,
wherein a first inter-layer insulator and a second inter-layer insulator are formed at an intersecting region between the first electrode group and the second electrode group,
wherein the second inter-layer insulator is formed in the outside of perimeter of the electron-emission area on the first inter-layer insulator, and
wherein the contact electrode is so formed as to cover a top and an edge facing the electron-emission area of the second inter-layer insulator.

11. The display apparatus according to claim 10,
wherein the first inter-layer insulating film is an anodization film.

12. The display apparatus according to claim 10,
wherein the contact electrode is connected to the first electrode on a side of the contact electrode,
wherein, on a side opposite to the side of the first electrode, undercut is formed below the first electrode.

13. The display apparatus according to claim 10,
wherein, of intersecting regions between the first electrode group and the second electrode group, an edge of the second electrode part is covered by the second inter-layer insulator.

14. The display apparatus according to claim 10,
wherein sheet resistance of the top electrode is 1 kilo-ohm per square or more.

15. The display apparatus according to claim 10,
wherein a patterning process of the second inter-layer insulating film is performed prior to a deposition process of the contact electrode.

16. A display apparatus comprising:
a cathode plate having: a plurality of thin-film electron emitters which have a base electrode, a top electrode, and an electron acceleration layer sandwiched between the base electrode and the top electrode and which emits electrons from a top electrode side by applying a voltage between the base electrode and the top electrode; a plurality of first electrode groups parallel to one another; and a plurality of second electrode groups parallel to one another, the first electrode groups being configured to feed power to the top electrode;
a display panel having a phosphor screen substrate having a phosphor screen where a phosphor is formed which is excited by the electrons to emit light; and
a drive circuit which drives the thin-film electron emitters,
wherein the first electrode group is electrically connected to a contact electrode, which is electrically connected to the top electrode,
wherein a first inter-layer insulator and a second inter-layer insulator are formed at an intersecting region between the first electrode group and the second electrode group,
wherein a patterning process of the second inter-layer insulating film is performed prior to a deposition process of the contact electrode.

17. A display apparatus comprising:
a cathode plate having: a plurality of thin-film electron emitters which have a base electrode, a top electrode, and an electron acceleration layer sandwiched between the base electrode and the top electrode and which emits electrons from a top electrode side by applying a voltage between the base electrode and the top electrode; a plurality of first electrode groups parallel to one another; and a plurality of second electrode groups parallel to one another, the first electrode groups being configured to feed power to the top electrode;
a display panel having a phosphor screen substrate having a phosphor screen where a phosphor is formed which is excited by the electrons to emit light; and
a drive circuit which drives the thin-film electron emitters,
wherein each electrode (first electrode) forming the first electrode group is in a stripe-form,
wherein a contact electrode electrically connected to the first electrode is provided which is electrically connected to the top electrode to thereby form a feeding side and provided along two or more adjacent feeding sides of the electron-emission area of the thin-film electron emitter,
wherein a first inter-layer insulator and a second inter-layer insulator are formed at an intersecting region between the first electrode group and the second electrode group,
wherein the second inter-layer insulator is formed in the outside of perimeter of the electron-emission area on the first inter-layer insulator, and
wherein the contact electrode is so formed as to cover a top and an edge facing the electron-emission area of the second inter-layer insulator.

18. The display apparatus according to claim 17,
wherein the first inter-layer insulating film is an anodization film.

19. The display apparatus according to claim 17,
wherein the contact electrode is connected to the first electrode on a side of the contact electrode,
wherein, on a side opposite to the side of the first electrode, undercut is formed below the first electrode.

20. The display apparatus according to claim 17,
wherein a film thickness of the contact electrode is smaller than a film thickness of the first electrode but larger than a film thickness of the top electrode.

21. The display apparatus according to claim 17,
wherein the contact electrode is in contact with a plurality of sides excluding a side opposite to the first electrode electrically connected to the thin-film electron emitter.

22. The display apparatus according to claim 17,
wherein the two or more adjacent sides include the longest side of sides of the electron-emission area of the thin-film electron emitter.

23. The display apparatus according claim 17,
wherein the two or more adjacent sides include, of the sides of the electron-emission area of the thin-film electron emitter, a side in a direction perpendicular to a direction of the first electrode group.

24. The display apparatus according to claim 17,
wherein a center of the electron-emission area is displaced from a center line of each electrode of the second electrode group.

25. The display apparatus according to claim 17,
wherein sheet resistance of the top electrode is 1 kilo-ohm per square or more.

26. The display apparatus according to claim 17,
wherein the contact electrode is provided at a layer between a layer of the first electrode group and a layer of the second electrode group.

27. The display apparatus according to claim 1,
wherein a material forming the contact electrode is higher (nobler) in a standard electrode potential than a material of a component having a smallest specific resistance among components forming the first electrode group.

28. The display apparatus according to claim 1,
wherein a material forming the contact electrode is any of chromium, molybdenum, molybdenum-chromium-nickel alloy, or an alloy including those just mentioned as components.
